(19) United States
(12) Patent Application Publication
(10) Pub. No.: US 2003/0211009 A1
(43) Pub. Date: Nov. 13, 2003

(54) Rapid multi-material sample input system

(76) Inventor: Kris S. Buchanan, Fort Collins, CO (US)

Correspondence Address: SANTANGELO LAW OFFICES, P.C., 125 SOUTH HOWES, THIRD FLOOR, FORT COLLINS, CO, 80521, US

(21) Appl. No.: 10/296,358

(22) PCT Filed: May 18, 2001
(86) PCT No.: PCT/US01/16243

(51) Int. Cl. G01N 35/00

(52) U.S. Cl. 422/63; 422/100

(57) ABSTRACT

Material transfer technology that apportions discrete amounts of material (1) and introduces the apportioned material into a selectably engaged flow path (17) to provide a plurality of separate materials within a continuous fluid stream that can be delivered to numerous material differentiation technologies (3) for analysis.

This application claims the benefit of U.S. Provisional Application No. 60/205,730, filed May 19, 2000, and that application is hereby incorporated by reference.

### I. TECHNICAL FIELD

Material transfer technology that apportions discrete amounts of material and introduces the apportioned material into a flow path to provide a plurality of separate materials within a continuous fluid stream that can be delivered to numerous material differentiation technologies for analysis or separation.

### II. BACKGROUND

The rapid supply of discrete amounts of material to a continuous fluid stream for analysis by various types of material differentiation technologies, such as, chromatographs, mass spectrometers, flow cytometers, fluorometers, spectrophotometers, or the like has numerous applications such as the profiling of pharmacological compounds, the study of ligand-receptor kinetics, estimating the number of individual particles within populations, and so forth. Understandably, there is great interest in increasing the rate at which small discrete amounts of material can be introduced into fluid streams because it can be the rate limiting step in analyzing the characteristics of the materials studied. As such, over the years, various technologies have been developed to increase the rate with which a large number of discrete amounts of material can be delivered for analysis to the various types of material differentiation systems. However, a number of significant problems remain unresolved with respect to these conventional material transfer technologies.

A significant problem with conventional material transfer technology may be the creation of pulsatile flow characteristics (variations in pressure or volume or both) in the fluid stream. As disclosed by U.S. Pat. No. 5,804,436, hereby incorporated by reference, some conventional technologies utilize peristaltic pumps to introduce materials into a fluid stream or to maintain the flow of a fluid stream within a fluid path. The fluid stream being conformably responsive to the peristalsis of the pump acquires corresponding volume and pressure differences which are then transmitted along the fluid stream to the material differentiation system responsive to the fluid stream. In the context of flow cytometer technologies, these volume and pressure differences can be manifested by a disruption of the laminar flow of the liquid fluid stream or an increased variation in droplet break off point from the fluid stream at the flow cytometer nozzle. Even with advanced fluid stream compensation technology these volume and pressure differences can make cell differentiation or cell sorting less efficient, impractical, or even impossible.

Another significant problem with conventional material transfer technology may be that bubbles are introduced into a liquid fluid stream. Certain conventional technologies interpose an amount of gas between discrete amounts of liquid material to maintain separation between them. In some cases, the interposed gas may then be delivered to the material differentiation system with the liquid materials for analysis. Delivering gas bubbles with the material to be analyzed, whether inadvertent or not, may not be compatible with some types of material differentiation technology, such as flow cytometry and high pressure liquid chromatography.

Another significant problem with conventional material transfer technology may be that it requires too much time to introduce material into the fluid stream and deliver the material to the material differentiation system. Conventional technology may be limited to introduction of 6-10 different discrete amounts of material every minute, or about 10 seconds to about 15 seconds per material sample. As described in U.S. Pat. No. 5,804,436, with respect to a method that measures the physiological response of cells to concentrations of agonist or antagonist the flow rate and the length of the reaction developing line were chosen so that a time interval of 40 seconds elapsed from the point at which cells mixed with the various compounds to the point at which the cells were interrogated.

Another significant problem with conventional material transfer technology may be that the core stream entraining material within a laminar flow path can be too wide. In some applications, for example, the width of the core stream can be important in presenting particles for interrogation in a serial fashion. In the flow cytometer context, a core stream having a narrow width reduces the number of events in which more than one individual particle is presented for interrogation (coincident events). As the core stream widens, the number of coincident events increases and the number of sorts per unit time may decrease as coincident events cannot be differentiated and are discarded. Attempts to increase the rate at which materials are processed by increasing the pressure of the liquid stream can generate an increased core stream width as materials are ejected from the injector flow path into the laminar flow path of the nozzle of the flow cytometer. As can be understood, for certain applications, the rate of introducing discrete amounts of material must also be accomplished within fluid stream parameters compatible with the material differentiation technology utilized.

Another significant problem with conventional material transfer technology may be that material introduced into the flow path has a concentration outside the range suitable for biological applications. With respect to the coincident events above-described as an example, attempts to reduce the concentration of cells per unit volume in a liquid stream by dilution can alter the extracellular environment so that it is no longer consistent with the normal functioning of the cells.

Another significant problem with conventional material transfer technology may be that rapidly introducing discrete amounts of materials into a fluid stream cross contaminates (mixes a portion of one discrete amount of material with a second discrete amount of material) the materials. For example, conventional flow path switching technology that provides a rotor having external loops that reciprocates between ports responsive to a stator to alternately engage two separate flow paths may carry the material from one flow path to the next. This can be particularly problematic when the materials in the respective flow paths cling to the surfaces of the flow paths. As such, conventional flow path switching technology can require relatively lengthy periods to evacuate the flow path of a first material prior to introducing a second material.

With respect to material transfer technology that apportions discrete amounts of material and introduces the apportioned material into a flow path, and specifically with regard the use of such material transfer technology in the flow cytometer context the instant invention addresses every one of the above-mentioned problems in a practical fashion.

### III. DISCLOSURE OF THE INVENTION

Generally the invention comprises various embodiments of material transfer apparatus and methods of transferring or introducing small discrete amounts of materials into a fluid stream. Specifically, the invention comprises various embodiments of selectably engaged flow paths and methods of selectably engaging flow paths to accomplish the rapid introduction of materials into a fluid stream to provide materials that can be analyzed by various types of material differentiation technology.

While the following description provides numerous examples of flow cytometer embodiments of the invention, it should be understood that the examples are meant to be illustrative of a sufficient number of embodiments of the invention to allow the ordinary person of skill in various fields of technology to make and use the invention in a broad variety of applications including, but not limited to, chromatography, mass spectrometry, fluorimetry, spectrophotometry, or the like.

Moreover, while certain examples of embodiments of the invention include a fluid stream, it should be understood that a fluid stream can be either a liquid or a gas, unless expressly limited to one or the other, and fluids should be understood to include all liquids that can be made to conformably flow in a flow path, such as, the numerous variety of organic or inorganic liquids, solvents, reagents, water, cell culture media, sheath fluids, eluants, combinations and permutations thereof, or the like, and also includes all gases whether purified, as mixtures, or atmospheric gases, or otherwise, regardless of the temperature, volume, pressure, or concentration, unless expressly limited.

Similarly, while certain embodiments of the invention involve the entrainment of cells within a liquid stream, it should be understood that the examples are illustrative of the broad variety of materials or particles that may be entrained including, but not limited to, biological particles such as cells, bacteria, proteins, peptides, amino acids, polynucleotides, nucleic acids, or the like, whether the component of the particle interrogated is on the surface or within the particle, and further includes particles, such as, solid supports, beads, stains, fluorescent labels, organic molecules, inorganic molecules, or the like.

As can be easily understood from the foregoing, the basic concepts of the present invention may be embodied in a variety of ways including various permutations and combination of the various elements and which may be scaled up or down. As such, the objects of the invention are similarly numerous and varied.

It is therefore, a broad object of embodiments of the invention to introduce discrete amounts of material into a continuous fluid stream. One aspect of this object can be to introduce discrete amounts of material without substantially changing the volume or the pressure of the fluid stream. Another aspect of this object can be to introduce discrete amounts of material into a fluid stream without substantially disrupting the laminar flow of the fluid stream. A third aspect of this object can be to introduce discrete amounts of material into a liquid fluid stream without introducing substantial amounts of gas.

Another significant object of embodiments of the invention can be to rapidly serially introduce a number of materials into a fluid stream in a short duration of time. One aspect of this object of the invention can be to introduce discrete amounts of different materials into a fluid stream serially about every 500 microseconds to about every 1 second. A second aspect of this object of the invention can be to accomplish such rapid introduction of different materials into the fluid stream without substantially disrupting the continuous fluid stream. A third aspect of this object of the invention can be to accomplish rapid introduction of different materials into a continuous fluid stream without a significantly broadening the fluid stream width as it exits a flow path into a larger laminar fluid stream flow.

Another significant object of embodiments of the invention can be to mix different materials in a small amount of volume within the flow path. A specific aspect of this object of the invention can be non-diffusional turbulent mixing of a discrete number of particles, such as cells, with a discrete volume of reagent substantially contacting the entirety of the surface area of all the particles with the reagent in a flow path volume of 20 microliters or less. Another aspect of embodiments of the invention can be to provide non-diffusional turbulent mixing of a discrete number of particles with a discreet amount of reagent and then incubate the particles within a flow path of less than 20 microliters for a specific amount of time prior to interrogating the particles.

Another significant object of embodiments of the invention can be to introduce biological materials, such as cells, into a fluid stream in sufficient numbers to establish a concentration that maintains the extracellular environment within a range compatible with biological functioning of the cells. One aspect of this object can be to maintain rapid introduction of different discrete amounts of materials or cells into the fluid stream at a pressure that does not substantially increase the core width of the stream as it exits the flow path into a larger laminar flow fluid stream. For example, flow cytometry embodiments of the invention can maintain the core width of the fluid stream containing separate discrete amounts of cells at a width between about two (2) micrometers to about three (3) micrometers at a pressure of about 66 pounds per square inch when ejected into a laminar flow sheath fluid stream having a pressure of 60 pounds per square inch. Importantly, the difference between the pressure of the fluid stream and the laminar flow into which the fluid stream is ejected is only about 6 pounds per square inch. As such, there is little retardation of the stream velocity and the core width can remain substantially the same as the flow path from which it was ejected.

Another significant object of embodiments of the invention can be to minimize cross contamination between separate discrete amounts of material even at high introduction rates into a fluid stream.

Another significant object of the invention can be to provide a selectably engaged flow path that can be rotationally engaged using single direction of rotation. One aspect of this object can be to eliminate conventional reciprocating flow path switching technology. A second aspect of this object of the invention can be to reduce the number of components comprising the selectably engaged flow path. A third aspect of this object can be to increase the speed at which the selectably engaged flow path can operate or the speed at which the serial steps of engaging a plurality of flow paths can be accomplished.

Naturally further objects of the invention are disclosed throughout other areas of to the specification and claims.

### IV. BRIEF DESCRIPTION OF THE DRAWINGS

FIG. 1 shows a generalized flow diagram of an embodiment of the invention.

FIG. 2 shows a generalized diagram of an embodiment of a material location coordinate tracker element.

FIG. 3 shows a generalized flow cytometer.

FIG. 4 shows a second view of a generalized flow cytometer.

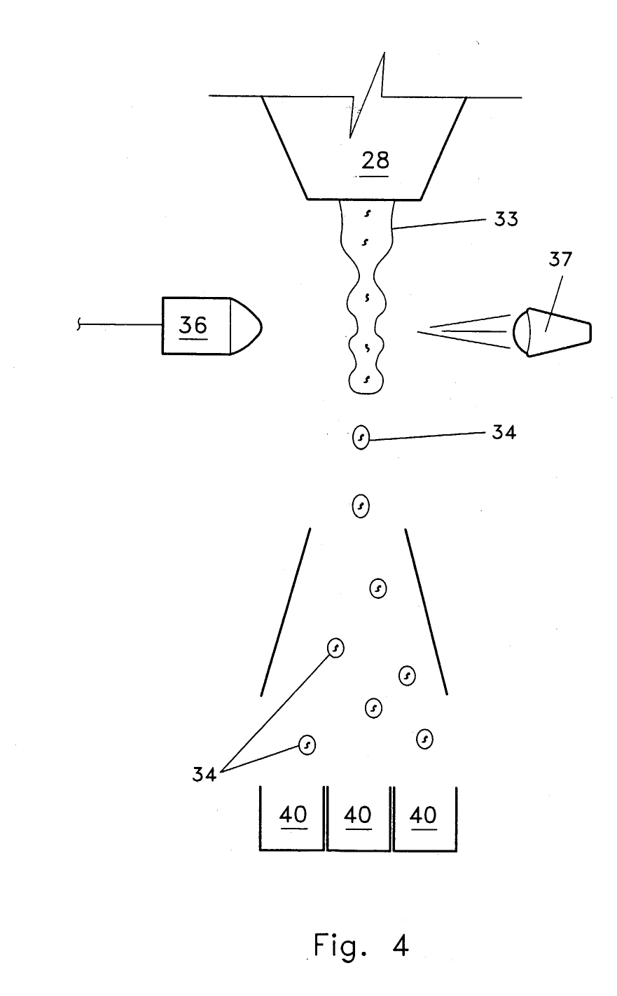

FIG. 5 shows an exploded diagram of an embodiment of the selectably engaged flow path invention.

FIG. 6 shows an embodiment of a rotational surface of the selectably engaged flow path invention having rotational surface recess elements.

FIG. 7 shows an embodiment of a rotational surface of the selectably engaged flow path invention having rotational surface recess elements.

FIG. 8 shows an embodiment of a rotational surface of the selectably engaged flow path invention having rotational surface recess elements.

FIG. 9 shows an embodiment of a rotational surface of the selectably engaged flow path invention having rotational surface recess elements.

FIG. 10 shows an embodiment of a rotational surface of the selectably engaged flow path invention having rotational surface recess elements.

FIG. 11 shows an embodiment of the invention having a rotational surface with rotational surface recess elements and a stationary surface having a stationary surface recess element.

FIG. 12 shows an embodiment of the invention having a rotational surface with rotational surface recess elements and a stationary surface having a stationary surface recess element.

FIG. 13 shows an embodiment of the invention having a rotational surface with rotational surface recess elements and a stationary surface having a stationary surface recess element.

FIG. 14 shows an embodiment of the invention having a rotational surface with pairs of rotational surface recess elements and a stationary surface having a stationary surface recess element.

FIG. 15 shows the fluid volume configuration corresponding to the alignment of a pair of rotatable enclosed volumes with a stationary enclosed volume.

FIG. 16 shows a fluidics schematic of an embodiment of the invention using two four port fluid path switching valves.

FIG. 17 shows a fluidics schematic of an embodiment of the invention using two four port fluid path switching valves.

FIG. 18 shows a fluidics schematic of an embodiment of the invention using two four port fluid path switching valves.

### V. MODE(S) FOR CARRYING OUT THE INVENTION

The invention involves material transfer technology that apportions discrete amounts of material and introduces the apportioned material into a flow path to provide a plurality of separate materials within a continuous fluid stream that can be delivered to numerous material differentiation technologies for analysis.

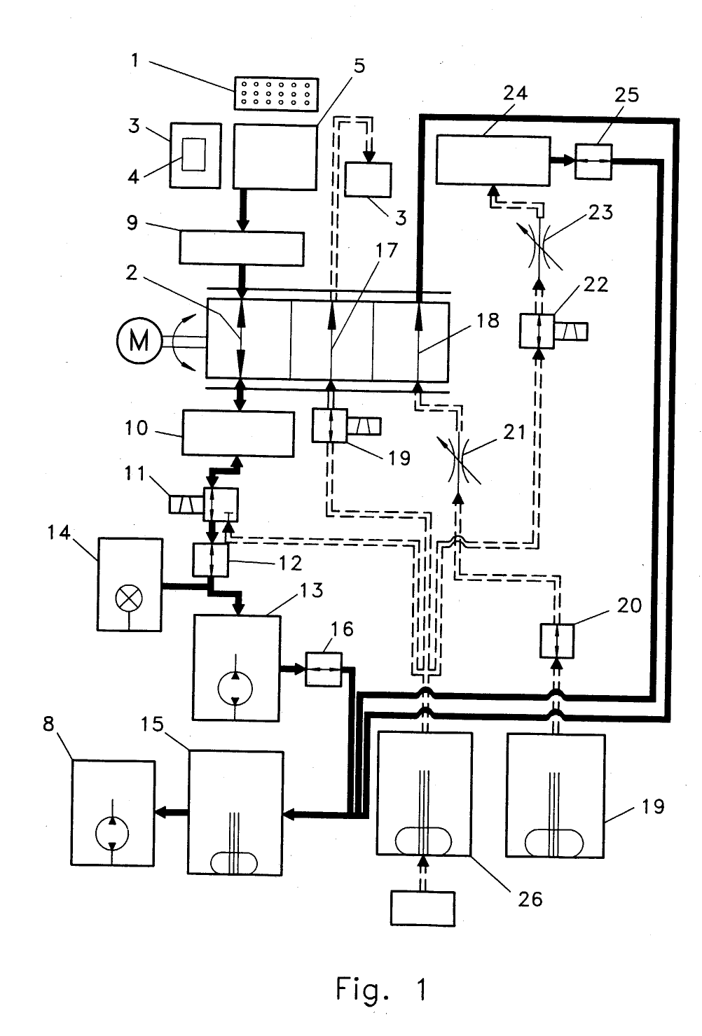

Now referring to FIG. 1, a preferred embodiment of a material transfer invention is shown. A basic embodiment of such a material transfer invention can comprise at least one material (1) having material location coordinates and a selectably engaged flow path (2) at least a portion of which can be fluidicly coupled to a material differentiation system (3). The material (1) transferred by the various embodiments of the invention can be any material that can flow within the selectably engaged flow path (2).

With respect to some embodiments of the invention, the material (1) can be a liquid, such as, water, solvents, reagents, cell culture media, stains, fluorescent labels, sheath fluids, or the like. Certain embodiments of the invention may further comprise materials, such as, particles, cells, or molecules entrained, suspended, or having a concentration in such a liquid, as further described above.

The material location coordinates can identify the location of a single amount of material among a plurality of individual amounts of materials. The location coordinates can correspond to the locations of materials arranged in various configurations that are typical with respect to a variety of applications, such as, fraction collector configurations, multiple welled tray configurations, or the like.

In certain embodiments of the invention, the material location coordinates can be input to a material locator system (3) that can have or be responsive to a programmable memory element (4). The programmable memory element (4) may be programmed with various material location coordinate tracker functions which can be used to instruct variety of types of material location coordinate tracker elements to operably coordinate with the various locations that present the various types of materials (1). The tracker functions can order the priority of interaction with the various material location coordinates and the residence time at each location. The tracker functions can also be further programmed to facilitate the transfer of a material(s) (1) from particular material location coordinates to a material transfer element (5), a selectably engaged flow path (2), or to another location. While certain embodiments of the invention specifically utilize a Cavro MSP-9000 AutoSampler, Cavro Scientific Instruments, Inc., 242 Humboldt Court, Sunnyvale, Calif. 94089 USA as described in the Cavro MSP-9000 Operators Manual, April 1996, Part 726507C, hereby incorporated by reference, it is understood that a variety of material location coordinate tracker elements can be used, such as, movable elements that travel to the various material location coordinates or move the location coordinates to stationary elements; or stationary elements, such as, electric switching valves located at each material location coordinate that can be made individually operably responsive to the material (1).

A material transfer element (5) can be made responsive to the material locator element (3). The material transfer element can comprise a material interaction element, which in the case of the Cavro MSP-9000, for example, can comprise a probe (6)(about a 0.010 inch internal flow path), or in the case of an electric switching valve can be the valve body configured to make the valve aperture responsive to the material (1). The material interaction element can be fluidicly coupled to the selectably engaged flow path (2), in which a pressure gradient can be generated with a pressure differential generation element (13). The pressure gradient generated within the engaged flow path (2) can draw the material (1) a distance into the selectably engaged flow path (7). A portion or all of the material (1) drawn into the selectably engaged flow path may then be directed to the material differentiation system (3). Alternately, as shown in FIG. 1, the material transfer element (5) and the material differentiation system (3) can be on separate selectably engaged flow paths.

The material transfer element can further comprise a bubble detector(s) (9)(10) responsive to the first selectably engaged flow path (2) to provide information concerning the position or velocity of the material within the selectably engaged flow path (2). A pressure differential generator (13) that can be made responsive to the bubble detectors to generate a pressure gradient within the first selectably engaged flow path (2) sufficient to draw material (1) into the rotatable enclosed volume of the first selectably engaged flow path (2), as discussed in detail below. A flow path back flush switching valve (11) can divert pressured liquid from a separate flow path to clean the portion of the first flow path after the selectably engaged portion, if desired. A first selectably engaged flow path pressure sensor (14) can be used to monitor the pressure of the fluid stream in the first fluid path.

A second selectably engaged flow path (17) can comprise a fluid source (26) having a variably adjustable fluid flow generation means to variably adjust the amount of fluid streaming within the second selectably engaged flow path (17). The variably adjustable fluid flow generation means ( ) could comprise a head pressure generated above a liquid in fluid source (26), but could also be a reciprocation pump, an apportioning pump, or otherwise depending on the material differentiation system (3) responsive to the second selectably adjustable flow path (17). An additional pressure application means (19) can be responsive to the second selectably engaged flow path (17) to assist the transfer of material (1) introduced into the second fluid stream, as discussed in detail below, to the material differentiation system (3). In certain embodiments of the invention, the fluid source (26) could contain a pressurized sheath fluid source which delivers sheath fluid to the second selectably engaged flow path (17) at a pressure of about 50 pounds per square inch to about 100 pounds per square inch depending upon the flow cytometry application. As described below, a portion of the first fluid stream containing material (1), such as a liquid entraining cells for certain flow cytometry applications, can be sequestered in a first rotatable volume that can be aligned with the second selectably engaged flow path (17) to introduce the material (1) into the second fluid stream and delivered to the material differentiation system (3). For flow cytometer embodiments of the invention the flow path may have a diameter of about 0.010 inches to about 0.020 inches and have a total volume from the rotatable enclosed volume to the flow cytometer of about 5 microliters to about 30 microliters. As such, the material (1) introduced into the second fluid stream can be delivered to the point of interrogation within the flow cytometer within a second, a half second, or even less. Material can be introduced from the first selectably engaged flo path (2) into the second selectably engaged flow path (17) about every 500 milliseconds to about every second, or at even higher rates of introduction such as about two to four different material introductions per second.

A third selectably engaged flow path (18) can comprise a second fluid source (19) having a second variably adjustable fluid flow generation means to variably adjust the amount of fluid streaming within the third selectably engaged flow path (17). The second variably adjustable fluid flow generation means (19) could comprise the wide variety of fluid flow generation means discussed above, or otherwise. The second fluid source (19) could comprise a wash fluid source containing a wash fluid responsive to the rotatable enclosed volume after introduction of material (1) into the second selectably engaged flow path (17).

The material differentiation system (3) can comprise any of numerous technologies that can utilize the rapid, precise, introduction of material(s) (1) made possible with embodiments of the selectably engaged flow path inventions. As such, it is understood that the material differentiation system (3) can be, but is not limited to, chromatographs, high pressure liquid chromatographs, mass spectrometers, flow cytometers, fluorometers, spectrophotometers, or the like.

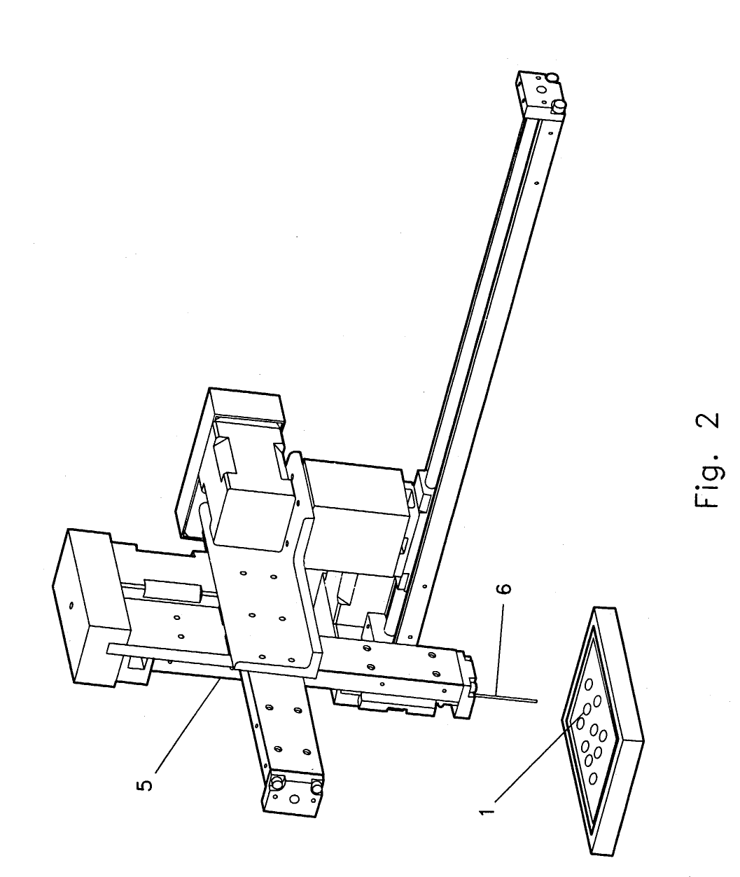

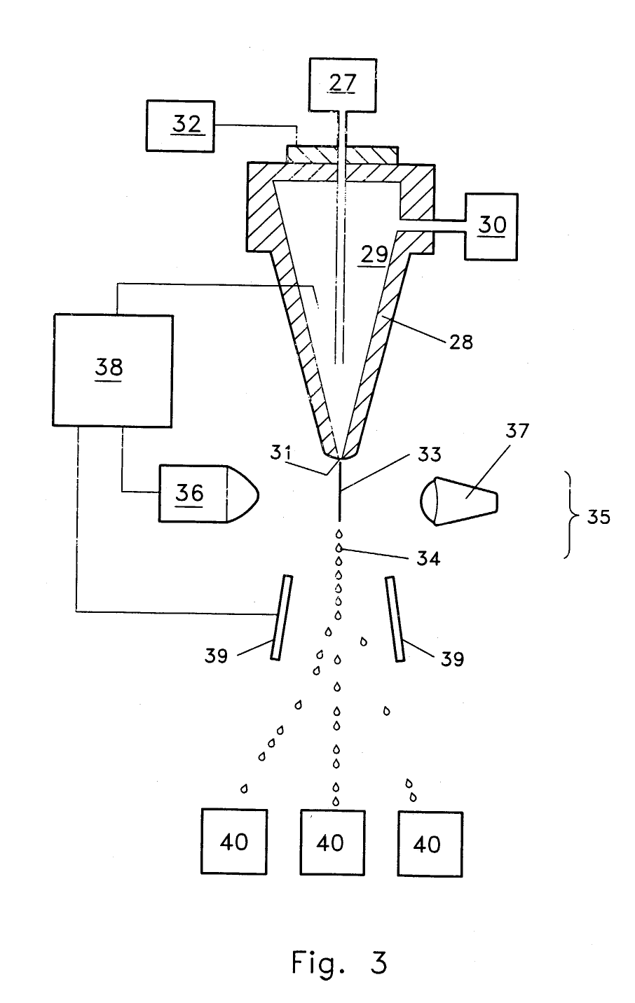

Now referring to FIGS. 2 and 3, a material differentiation system (3) can comprise a flow cytometer which includes a particle or cell source (27) which acts to establish or supply particles or cells. The particles or cells are deposited within a nozzle (28) in a manner such that the particles or cells are introduced into a fluid stream or sheath fluid (29). The sheath fluid (29) is usually supplied by some sheath fluid source (30) so that as the particle or cell source (27) supplies the particles or cells into the sheath fluid (29) they are concurrently fed through the nozzle (28).

In this manner it can be easily understood how the sheath fluid (29) forms a sheath fluid environment for the particles or cells. Since the various fluids are provided to the flow cytometer at some pressure, they flow out of the nozzle (28) and exit at the nozzle orifice (31). By providing some type of oscillator (31) which may be very precisely controlled through an oscillator control (32), pressure waves may be established within the nozzle (28) and transmitted to the fluids exiting the nozzle (28) at nozzle orifice (31). Since the oscillator (31) acts upon the sheath fluid (29), the stream (33) exiting the nozzle orifice (31) eventually and regularly forms drops (34). Because the particles or cells are surrounded by the fluid stream or sheath fluid environment, the drops (34) may entrain within them individually isolated particles or cells.

Since the drops (34) can entrain particles or cells, the flow cytometer can be used to separate particles, cells, or the like based upon particle or cell characteristics. This is accomplished through a particle or cell sensing system (10). The particle or cell sensing system involves at least some type of detector or sensor (36) which responds to the particles or cells contained within fluid stream (33). The particle or cell sensing system (35) may cause an action depending upon the relative presence or relative absence of a characteristic, such as fluorochrome bound to the particle or cell or the DNA within the cell that may be excited by an irradiation source such as a laser exciter (37) generating an irradiation beam to which the particle can be responsive. While each type of particle, cell, or the nuclear DNA of cells may be stained with at least one type of fluorochrome different amounts of fluorochrome bind to each individual particle or cell based on the number of binding sites available to the particular type of fluorochrome used.

In order to achieve separation and isolation based upon particle or cell characteristics, emitted light can be received by sensor (36) and fed to some type of separation discrimination system or analyzer (38) coupled to a droplet charger which differentially charges each droplet (34) based upon the characteristics of the particle or cell contained within that droplet (34). In this manner the separation discrimination system or analyzer (38) acts to permit the electrostatic deflection plates (39) to deflect drops (34) based on whether or not they contain the appropriate particle or cell (41).

As a result, the flow cytometer acts to separate the particle or cells by causing them to be directed to one or more collection containers (40). For example, when the analyzer differentiates cells based upon a cell characteristic, the droplets entraining the cell having a certain cell characteristic of interest can be charged positively and thus deflect in one direction, while the droplets entraining cells having a different cell characteristic can be deflected in at least one other direction, and the wasted stream (that is droplets that do not entrain a particle or cell or entrain undesired or unsortable cells) can be left uncharged and thus is collected in an undeflected stream into a suction tube or the like as discussed in U.S. patent application Ser. No. 09/001,394, hereby incorporated by reference. Naturally, numerous deflection trajectories can be established and collected simultaneously.

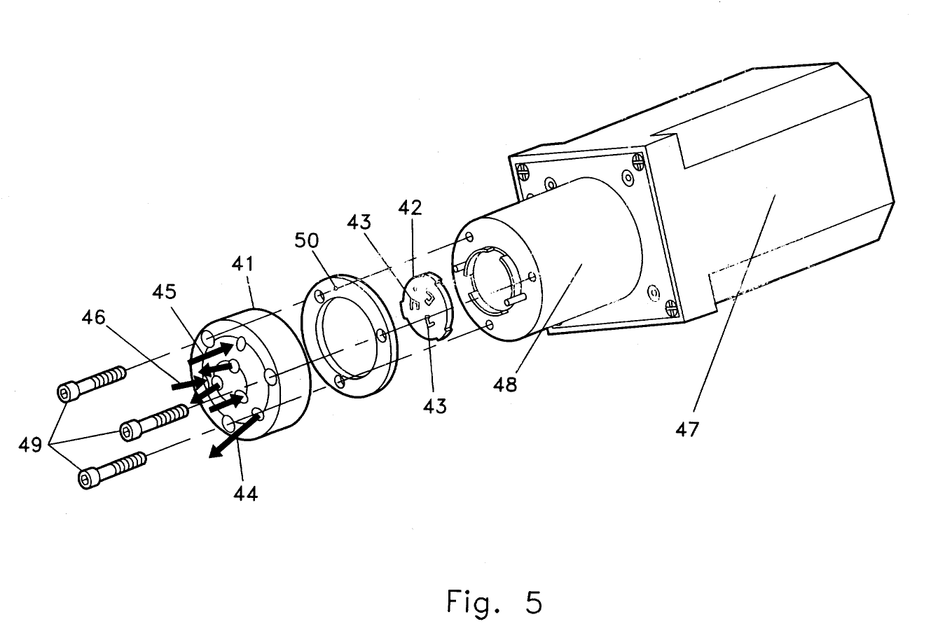

Now referring to FIG. 5, an embodiment of a selectably engaged flow path is shown. A basic embodiment of a selectably engaged flow path can comprise a stationary surface (41) and a rotatable surface (42) that can be rotatably engaged with the stationary surface (41), and at least one rotatable surface recess element (43). When the stationary surface (41) and the rotatable surface (42) are rotatably engaged a rotatable enclosed volume can be defined. The stationary surface (41) can be perforated with a first pair apertures (44) or ports with which at least one rotatable enclosed volume can be aligned to engage a first flow path (2). By flowing a first fluid stream (44) within the first engaged flow path (2) the volume of the at least one rotatable enclosed volume (43) can be filled with an amount of material (1), such as, cells entrained in a liquid. By rotating the rotatable surface (43) a portion of the first fluid stream (44) can be sequestered in the rotatable enclosed volume. Further rotation of the rotatable surface (42) can bring the rotatable enclosed volume into alignment with a second pair of apertures (46) or ports engaging a second flow path (17). Upon alignment with the second flow path (17) the portion of the first fluid stream (44) sequestered in the rotatable enclosed volume can be introduced into the second flow path (17). A second fluid stream (45) within the second flow path (17) can deliver the portion of the first fluid stream (44) introduced into the second flow path (17) to a target location, such as a particle differentiation system (3). As shown in FIG. 5, a plurality of rotatable enclosed volumes can be defined by the rotatable surface (42) when rotatably engaged with the stationary surface (41). While FIG. 5 shows, three rotatable surface recess elements (43) each of which can become a rotatable enclosed volume upon engagement with the stationary surface (41), it can be understood that there may be only one or may be numerous rotational surface recess elements as desired. Moreover, when a plurality of rotatable enclosed volumes are defined each may selectably engage a plurality of flow paths, such as a first flow path (2), a second flow path (17), or a third flow path (18), or more can be engaged simultaneously. As such, a separate fluid stream, such as a first fluid stream (44), a second fluid stream (45), a third fluid stream (46), or more can simultaneously flow within each the flow paths.

Embodiments of the invention having three selectably engaged flow paths as shown in FIGS. 1 and 5, allows a single (or a plurality of) rotatable enclosed volume(s) to be serially engaged with the first flow path (2), the second flow path (17), and then the third flow path (18), or as many serial flow paths as may be desired, by rotating the rotatable surface (41) in a single direction of rotation, thereby eliminating the need for reciprocation between two flow paths, if desired. In some embodiments of the invention, the first fluid stream can comprise materials (1) transferred into the rotatable enclosed volume aligned with the first fluid path (2), while the second fluid stream can comprise the introduction of a previously sequestered portion of the first fluid stream (44) into the second flow path (18) delivered to the material differentiation system, while the third fluid stream (46) can comprise a cleaning solution to wash the rotatable enclosed volume aligned with the third flow path (18). By simultaneously engaging three separate flow paths to three separate rotatable enclosed volumes, three separate distinct functions can simultaneously be performed thereby reducing the amount of time to introduce material (1) into the flow path delivered to the material differentiation system (3). Certain embodiments of the invention used in the flow cytometer context having three selectably engaged flow paths can introduce a different material from the first flow path (2) into the second flow path (18) about every 500 milliseconds to about every one second while substantially maintaining a continuous fluid stream, as discussed above. Naturally, for other applications the introduction of different materials could be even faster or slower as desired.

As further shown in FIG. 5, the rotatable surface (42) can be responsive to a drive unit (47) with transmission means (48) which rotates the rotatable surface (42). The stationary surface (41) and the rotational surface (42) can be fixed in an rotatably engaged position by retaining means (49), such as the mechanical fasteners shown, with a spacer (50) maintaining the proper amount of pressure between the rotatable surface (42) and the stationary surface (41) to seal the rotation surface recess elements (43) with the stationary surface so that the defined rotatable enclosed volumes are sufficiently sealed to substantially prevent material (1) or fluids sequestered within the rotatable enclosed volumes from migrating between the two surfaces.

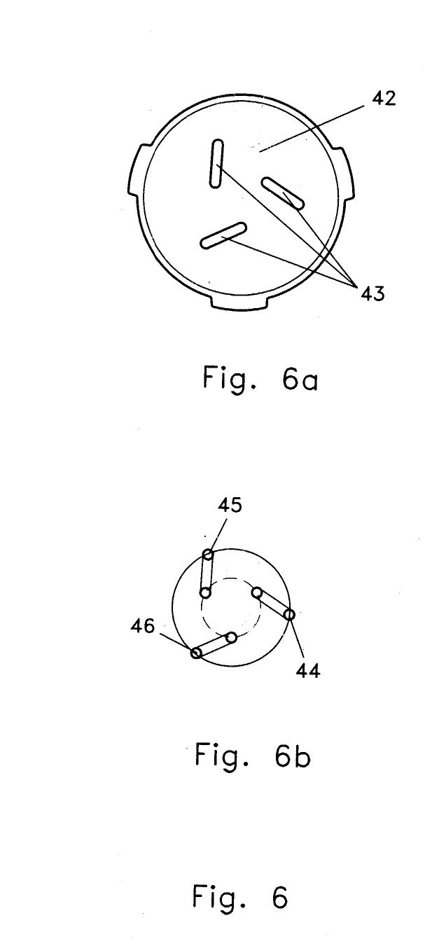

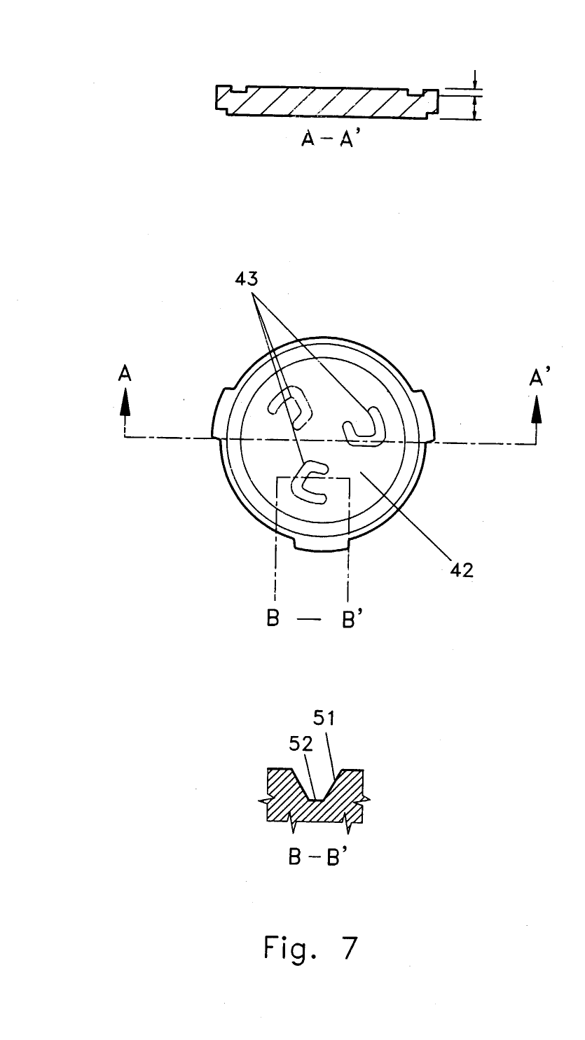

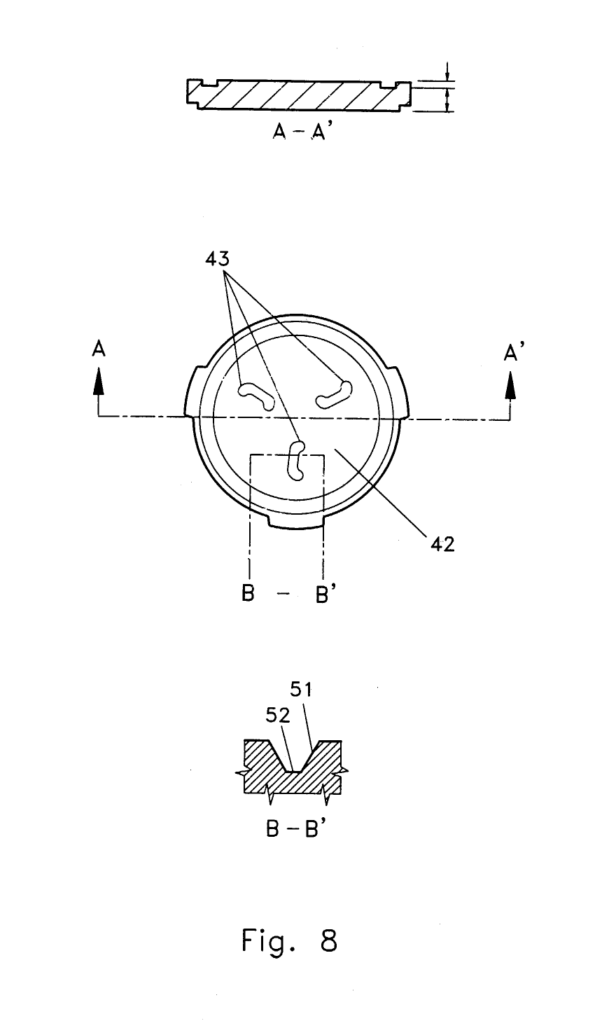

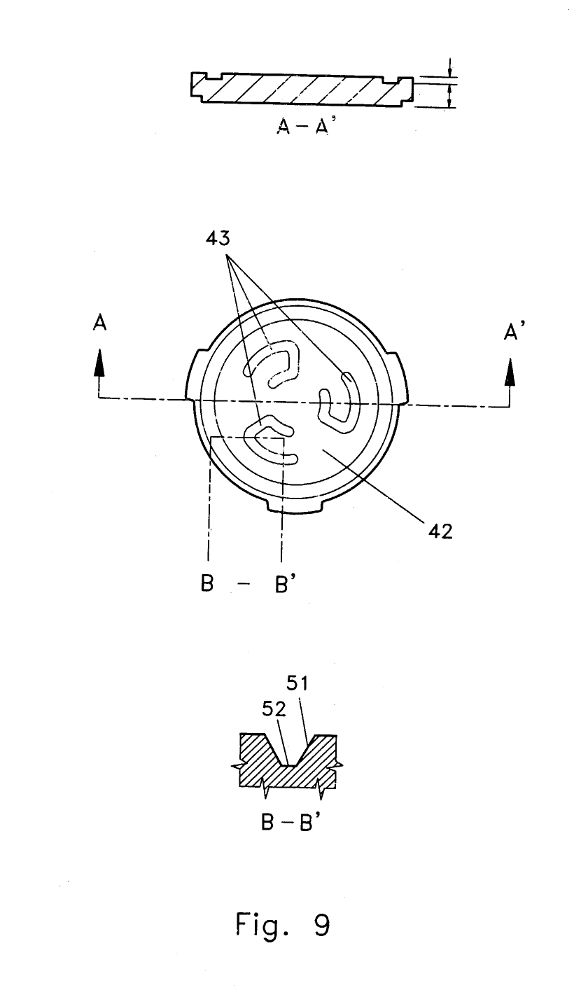

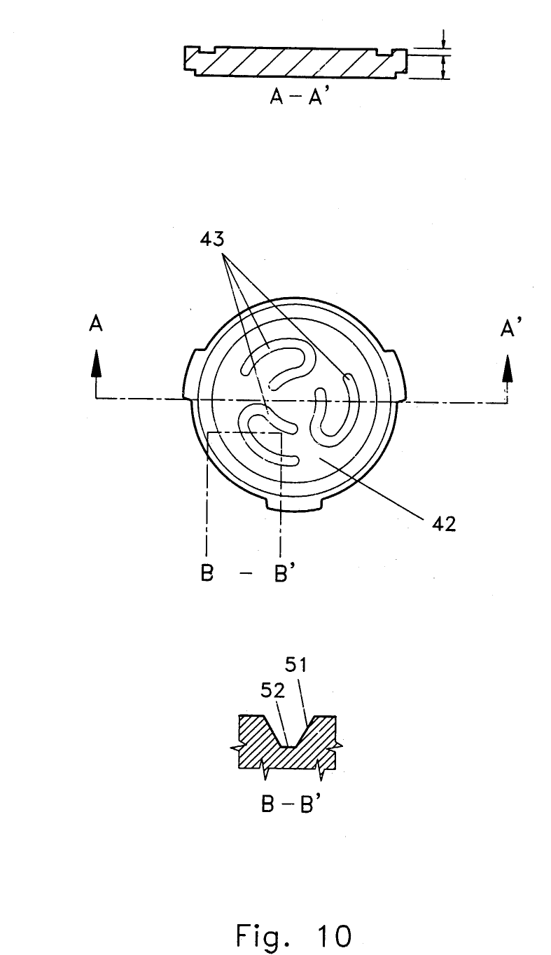

Now referring to FIGS. 6-10, various embodiments of the rotatable surface (42) having a variety of rotatable surface recess elements (43) are shown. As can be understood from the figures the rotatable surface recess elements (43) can made with numerous configurations to hold selectable volumes of fluid or material (1) as desired for a particular application. The amount of volume for flow cytometer applications, for example, can be from about microliter to about five microliters. Certain embodiments of the rotatable surface recess elements can have inclined side walls (51) coupled to a planar base (52). For flow cytometry applications the base can have a width of about 0.010 inches while the top of the rotatable surface recess element can be about 0.034 inches with side walls (51) inclined 30 degrees from perpendicular with the base (52), as but one example. Other embodiments can have a base of 0.005 inches in width and side walls inclined 20 degrees from perpendicular with the base (naturally other configurations are possible depending on the application). It should be understood that rotatable surface recess elements (43) could be configured with a variety of suitable geometries other than those shown in the figures and the figures are illustrative of a sufficient number of embodiments that the broad range of rotatable surface recess elements can be designed for other applications without undue experimentation.

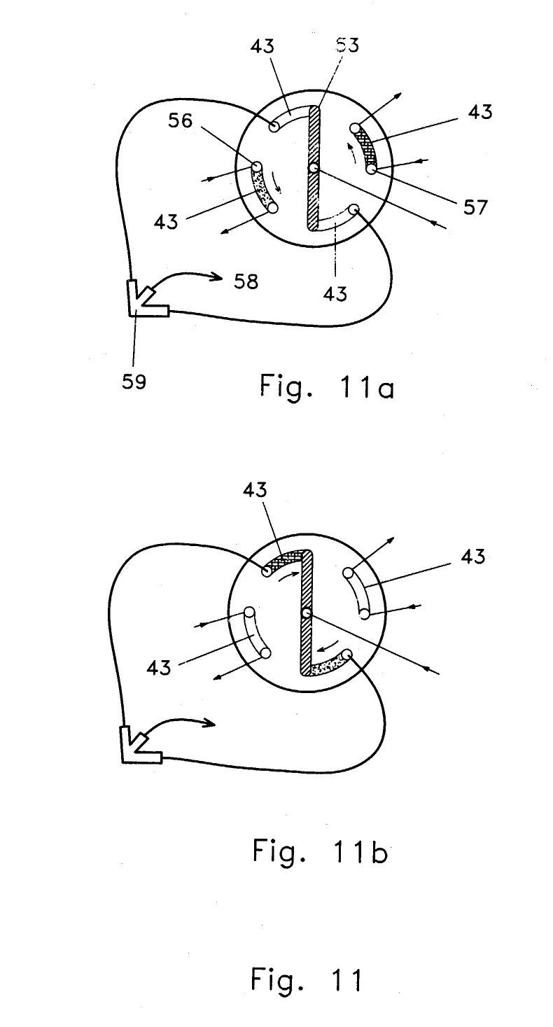

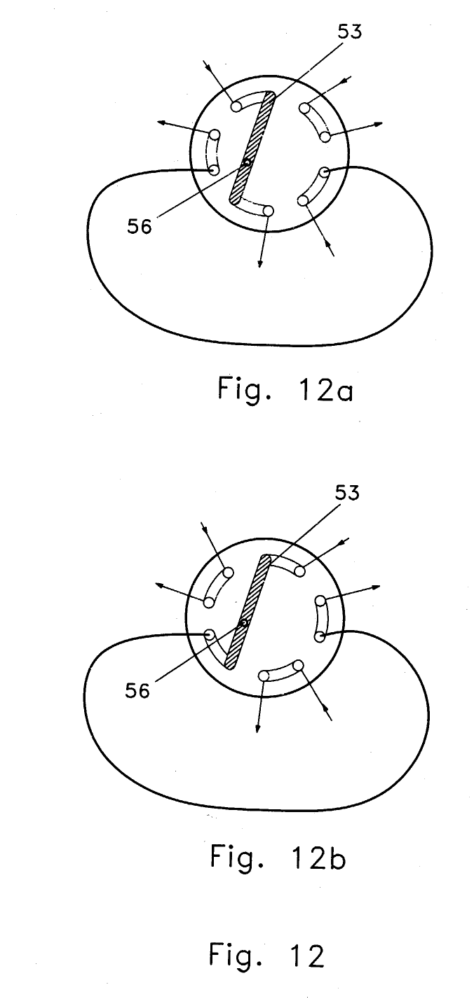

Now referring to FIGS. 11-14, embodiments of the invention are shown that further comprise a stationary surface recess element (53) that forms a stationary enclosed volume (54) when the stationary surface (41) and the rotatable surface (43) are rotatably engaged. As can be understood, at least one rotatable enclosed volume (55) can be rotatably aligned with the stationary enclosed volume to selectably engage a flow path. Certain embodiments of the invention provide a plurality of rotatable enclosed volumes (54) to align with the stationary enclosed volume at the same time. As shown in each of FIGS. 12-14 two rotatably enclosed volumes (55) are aligned with the stationary enclosed volume (54) to introduce a portion of the fluid streams from two separate fluid paths into a single flow path. The stationary enclosed volume (54) can hold an amount of liquid of less than about two microliters with respect to certain embodiments of the invention, and the rotatable enclosed volumes (55) that align with the stationary enclosed volume (54) can hold about one to about five microliters of liquid. As can be understood from FIG. 11, a first flow path (56) can be selectably engaged and a fluid stream comprising material (1) be sequestered in a first rotatable enclosed volume (55), while simultaneously, a second flow path (57) can be selectably engaged and a fluid stream comprising a reagent (or any type of material or fluid conformably flowable in the flow path) can be sequestered in a second rotatably enclosed volume (55). By rotating the rotatable surface (42) both of the rotatable enclosed volumes (55) can be aligned with the stationary enclosed volume (54). The two sequestered portions of the first fluid stream and the second fluid stream can then be conjoined into a common fluid stream (58). As illustrated by FIGS. 11 and 12, the two sequestered portions of the first fluid path and the second fluid path can be conjoined either by flowing a fluid stream to a the stationary enclosed volume and then through the two separate rotatable enclosed volumes to a T-fitting (as shown in FIG. 11), or alternately by flowing a separate fluid streams to each of the two rotatable enclosed volumes and having the two streams conjoin at location along the stationary enclosed volume (54) as shown in FIG. 12.

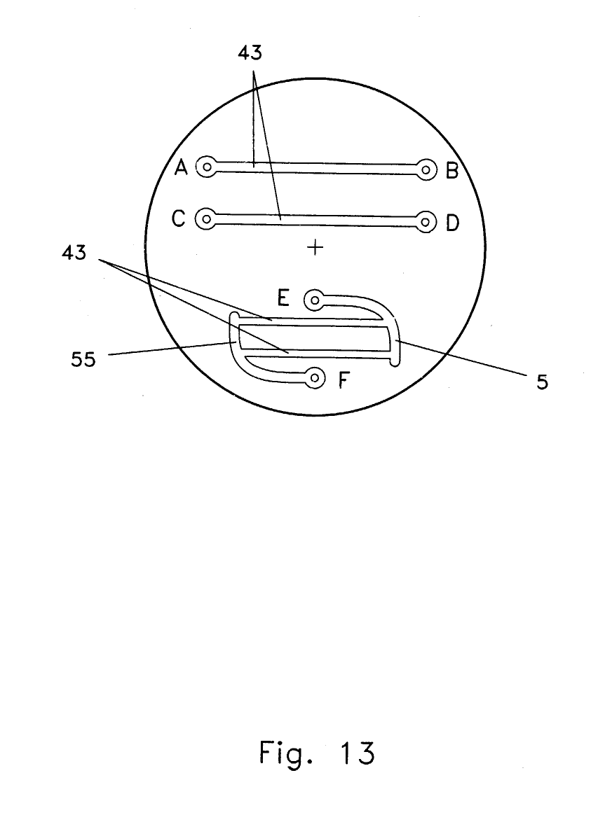

As shown by FIG. 13, plurality of stationary surface recess elements (53) can be configured to provide a plurality of stationary enclosed volumes (54). The embodiment of the invention shown by FIG. 13 comprises three flow paths, a first engaged upon alignment of the stationary enclosed volume (54) with two rotatable enclosed volumes (55), a second engaged upon alignment of a third rotatable enclosed volume, and a third engaged upon alignment with a fourth rotatable enclosed volume.

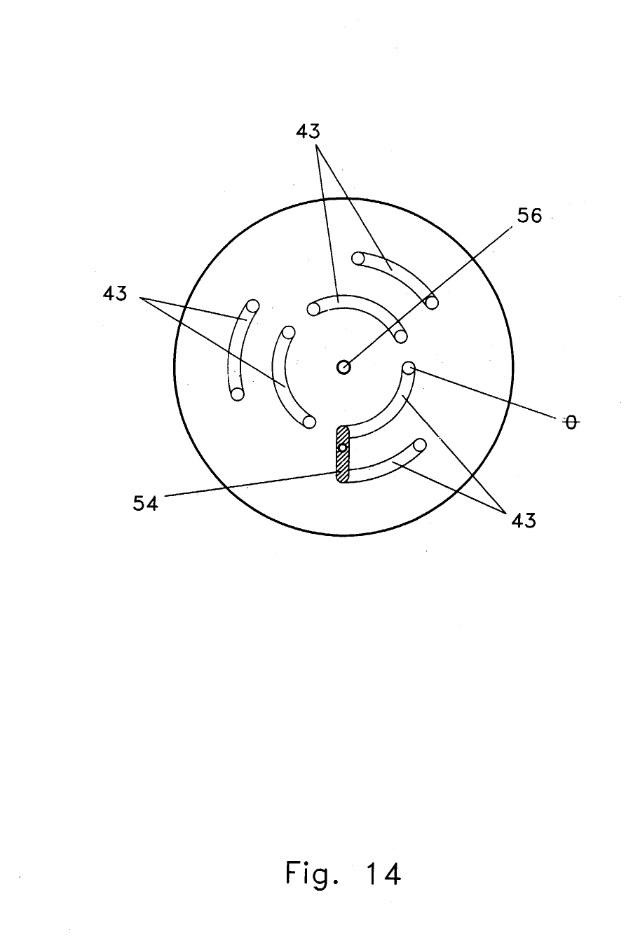

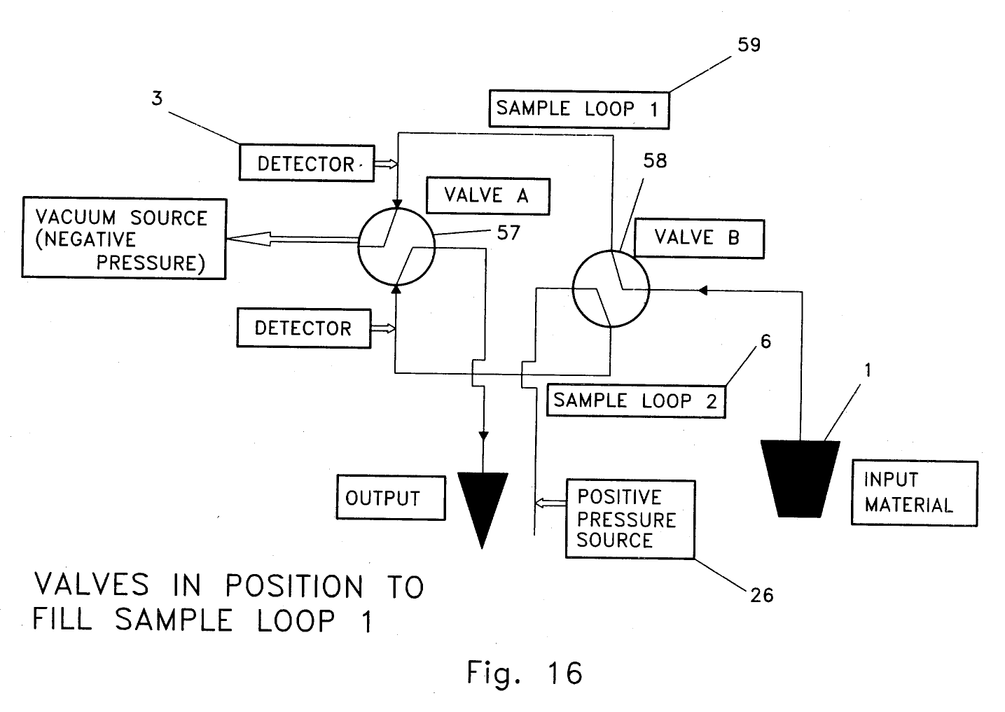

As shown by FIG. 14, the rotatable enclosed volumes can be configured as three pairs, in a first position, a first rotatable enclosed volume (43) of the pair can sequester material (1) such as cells entrained in a liquid from a first fluid path while the second enclosed volume sequesters a reagent from a separate second fluid path. By rotating the pair of rotatable enclosed volumes to a second position, the first enclosed volume of the pair and the second enclosed volume of the pair align with a stationary enclosed volume. Importantly, non-diffusional turbulent mixing of the material (1) sequestered by first rotatable enclosed volume and the reagent sequestered by the second rotatable of the pair can occur in a limited volume fluid path (i.e. 20 microliters or less) over a desired duration of time. The duration of time can be less than one second if delivered directly to the material differentiation system, or the material (1) and the reagent can be incubated by reducing the pressure of the fluid streams to the first and the second rotatable enclosed volumes. Upon completion of the incubation period the pressure of the respective fluid streams can be increased to deliver the reacted material or product to the material differentiation system. It should be understood that the configuration of the pair of rotatable enclosed volumes aligned with the stationary enclosed volume as shown in FIG. 16 allows a limited volume non-diffusional turbulent mixing of the two types of sequestered fluids in the conjoined fluid path (about 1 to 10 microliters). The invention can further comprise rotatable enclosed volumes of different holding capacity, and can further comprise variably adjustable rates of introduction into the conjoined flow path (56) from each of the rotatable enclosed volumes (55). The variable adjustable rates of introduction from each rotatable enclosed volume (54) can be adjusted based upon real time analysis of the leading edge of reacted material by the material differentiation system. As such, the adjustable rate of introduction into the conjoined fluid stream (56) can respond differentially to a rate of product formation as determined at the interrogation point in the material differentiation system.

In a third position the pair of rotatable enclosed volumes can be aligned with a pair of fluid streams to clear the rotatable enclosed of any residual material or reagents, or the like.

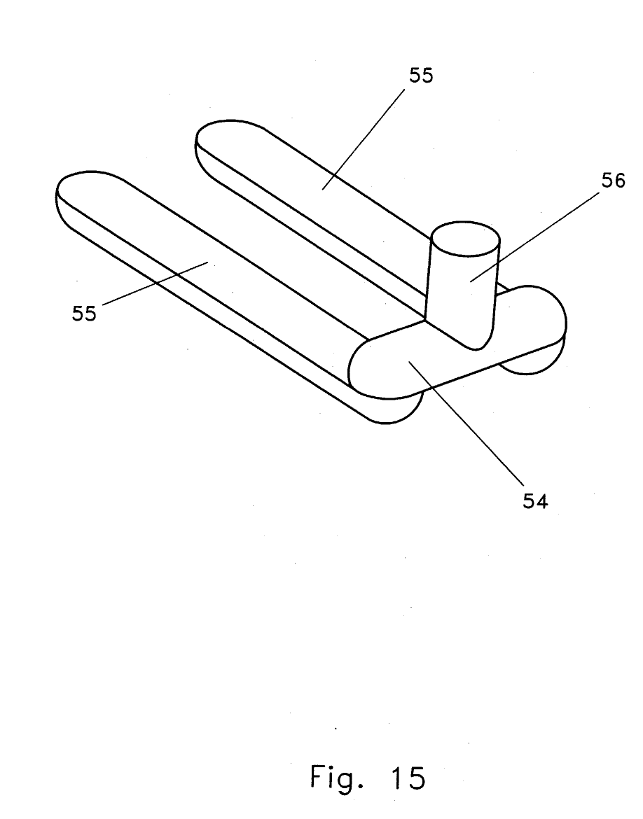

It can be understood that any of the embodiments of the selectably engaged flow path inventions or fluid streaming methods illustrated by FIGS. 5-15, or combinations or permutations thereof, or that would be understood to be encompassed in the broad range of selectably engaged flow path inventions based upon the foregoing description along with any equivalents thereof, could be used in the material transfer invention illustrated by FIG. 1. With respect to the various material differentiation system applications that can utilize the invention, minor flow path modification could be made without undue experimentation.

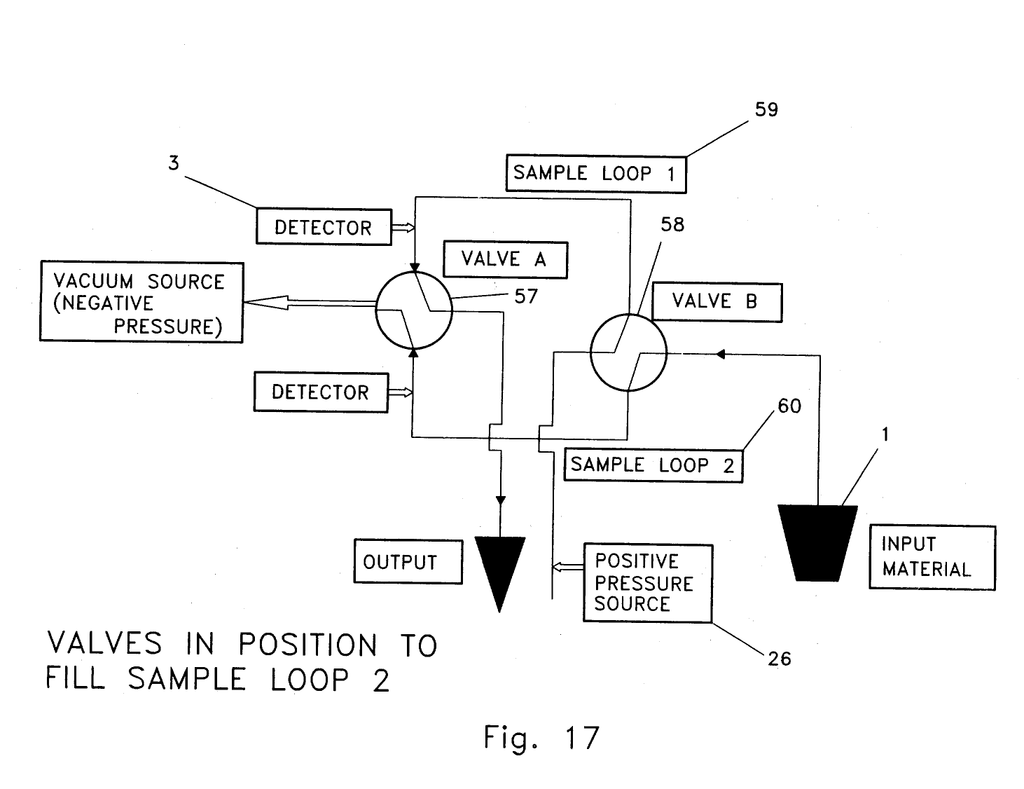

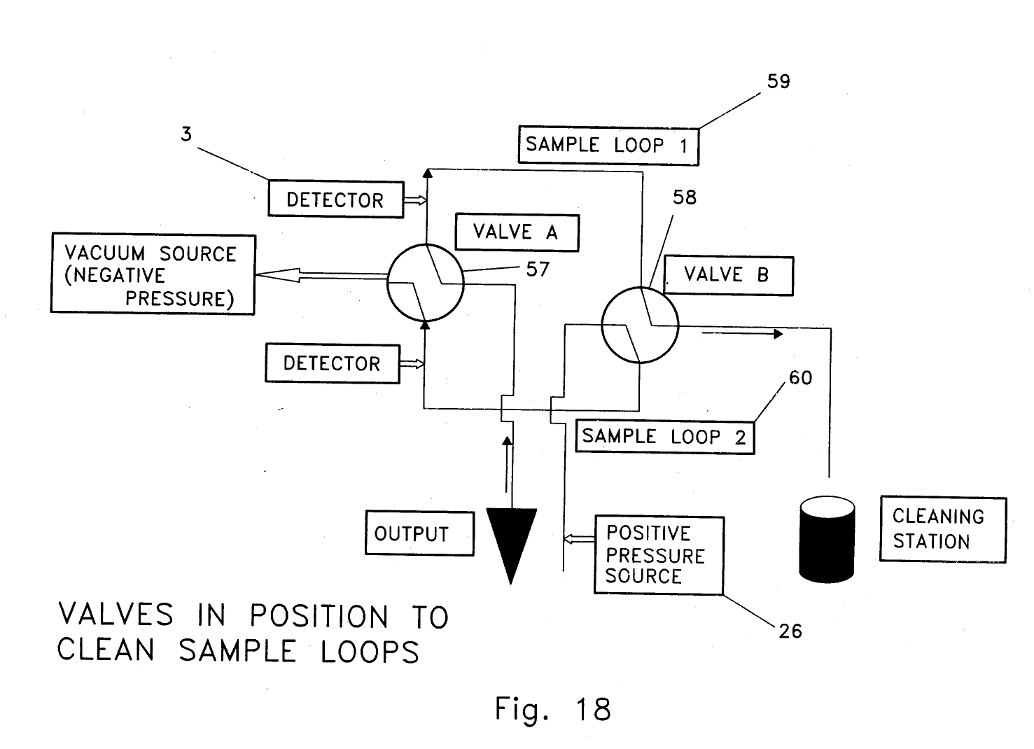

Now referring to FIGS. 17, 18 and 19, embodiments of the invention can comprise more than a single selectably engaged flow path, or can be accomplished with two four port fluid path switching valves (57)(58). Two four port fluid path switching valves with tubing placed between them can create a sample loop A (59) and a sample loop B (60). The two valves may be four-port valves with two operating positions. The input material (1) may be introduced by moving a stainless steel tube over and into a vessel of sample material or by using a material transfer system as described above. Any amount of sample material (1) may be drawn into the sample loop as shown in FIG. 16. Once the sample loop is full, the two valves may be switched as shown in FIG. 17. At any time a cleaning state may be created for the sample loops by switching one of the valves as shown in FIG. 18.

The discussion included in this PCT application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in functionally-oriented terminology, each aspect of the function is accomplished by a device, subroutine, or program. Apparatus claims may not only be included for the devices described, but also method or process claims may be included to address the functions the invention and each element performs. Neither the description nor the terminology is intended to limit the scope of the claims which now be included.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “droplet separator” should be understood to encompass disclosure of the act of “separating droplets”—whether explicitly discussed or not—and, conversely, were there only disclosure of the act of “converting liquid-gas”, such a disclosure should be understood to encompass disclosure of a “droplet separator” and even a means for “separating droplets”. Such changes and alternative terms are to be understood to be explicitly included in the description.

Additionally, the various combinations and permutations of all elements or applications can be created and presented. All can be done to optimize the design or performance in a specific application.

Any acts of law, statutes, regulations, or rules mentioned in this application for patent: or patents, publications, or other references mentioned in this application for patent are hereby incorporated by reference. Specifically, U.S. Patent Application Nos. 60/267,571, 60/239,752, and 60/203,089 are each hereby incorporated by reference herein including any figures or attachments, and each of references in the following table of references are hereby incorporated by reference.

| DOCUMENT | | | | | FILING |
|---|---|---|---|---|---|
| NO. | DATE | NAME | CLASS | SUBCLASS | DATE |
| 3,299,354 | Dec. 17, 1967 | Hogg | 207 | 582 | Jul. 5, 1962 |
| 3,661,460 | May 9, 1972 | Elking et al. | 356 | 36 | Aug. 28, 1970 |
| 3,710,933 | Jan. 16, 1973 | Fulwyler et al | 209 | 3 | Dec. 23, 1971 |
| 3,761,941 | Sep. 25, 1973 | Robertson | 346 | 1 | Oct. 13, 1972 |
| 3,810,010 | May 7, 1974 | Thom | 324 | 71 | Nov. 27, 1972 |
| 3,826,364 | Jul. 30, 1974 | Bonner et al | 209 | 3 | May 22, 1972 |
| 3,833,796 | Nov. 3, 1974 | Fetner et al | 235 | 151.3 | Oct. 13, 1971 |
| 3,960,449 | Jul. 1, 1976 | Carleton et al | 356 | 103 | Jun. 5, 1975 |
| 3,963,606 | Jun. 15, 1976 | Hogg | 209 | 3 | Jun. 3, 1974 |
| 3,973,196 | Aug. 3, 1976 | Hogg | 324 | 71 | Jun. 5, 1975 |
| 4,014,611 | Mar. 29, 1977 | Simpson et al | 356 | 72 | Apr. 30, 1975 |
| 4,070,617 | Jan. 24, 1978 | Kachel et al | 324 | 71 | Aug. 3, 1976 |
| 4,162,282 | Jul. 24, 1979 | Fulwyler et al | 264 | 9 | Apr. 22, 1976 |
| 4,230,558 | Oct. 28, 1980 | Fulwyler | 209 | 3.1 | Oct. 2, 1978 |
| 4,302,166 | Nov. 24, 1981 | Fulwyler et al | 425 | 6 | Mar. 15, 1979 |
| 4,317,520 | Mar. 2, 1982 | Lombardo et al | 209 | 3.1 | Aug. 20, 1979 |
| 4,318,480 | Mar. 9, 1982 | Lombardo et al | 209 | 3.1 | Aug. 20, 1979 |
| 4,318,481 | Mar. 9, 1982 | Lombardo et al | 209 | 3.1 | Aug. 20, 1979 |
| 4,318,482 | Mar. 9, 1982 | Barry et al | 209 | 3.1 | Aug. 20, 1979 |
| 4,318,483 | Mar. 9, 1982 | Lombardo et al | 209 | 3.1 | Aug. 20, 1979 |
| 4,325,483 | Apr. 20, 1982 | Lombardo et al | 209 | 3.1 | Aug. 20, 1979 |
| 4,341,471 | Jul. 27, 1982 | Hogg et al | 356 | 343 | Jan. 2, 1979 |
| 4,350,410 | Sep. 21, 1982 | Minott | 350 | 170 | Oct. 8, 1980 |
| 4,361,400 | Nov. 30, 1982 | Gray et al | 356 | 23 | Nov. 26, 1980 |
| 4,395,397 | Jun. 6, 1905 | Shapiro | | | |
| 4,395,676 | Jul. 26, 1983 | Hollinger et al | 324 | 71.4 | Nov. 24, 1980 |
| 4,400,764 | Aug. 23, 1983 | Kenyon | 362 | 263 | May 19, 1981 |
| 4,487,320 | Dec. 11, 1984 | Auer | 209 | 3.1 | Nov. 3, 1980 |
| 4,498,766 | Feb. 12, 1985 | Unterleitner | 356 | 73 | Mar. 25, 1982 |
| 4,515,274 | May 7, 1985 | Hollinger et al | 209 | 3.1 | Dec. 2, 1981 |
| 4,523,809 | Jun. 18, 1985 | Toboada et al | 350 | 163 | Aug. 4, 1983 |
| 4,538,733 | Nov. 3, 1985 | Hoffman | 209 | 3.1 | Oct. 14, 1983 |
| 4,598,408 | Jul. 1, 1986 | O'Keefe | 372 | 94 | Oct. 22, 1984 |
| 4,600,302 | Jul. 15, 1986 | Sage, Jr. | 356 | 39 | Mar. 26, 1984 |
| 4,631,483 | Dec. 23, 1986 | Proni et al | 324 | 71.4 | Feb. 1, 1984 |
| 4,673,288 | Jun. 16, 1987 | Thomas et al | 356 | 72 | Nov. 7, 1984 |
| 4,691,829 | Sep. 8, 1987 | Auer | 209 | 3.1 | Dec. 6, 1984 |
| 4,702,598 | Oct. 27, 1987 | Böhmer | 356 | 343 | Feb. 25, 1985 |
| 4,744,090 | May 10, 1988 | Freiberg | 372 | 94 | Jul. 8, 1985 |
| 4,756,427 | Jun. 11, 1905 | Schumann | | | |
| 4,758,729 | Jul. 19, 1988 | Monnin | 250 | 560 | Aug. 28, 1987 |
| 4,794,086 | Jan. 27, 1988 | Kasper et al | 436 | 36 | Nov. 25, 1985 |
| 4,818,103 | Apr. 4, 1989 | Thomas et al | 356 | 72 | Jan. 20, 1987 |
| 4,831,385 | May 16, 1989 | Archer et al | 346 | 1.1 | Oct. 14, 1987 |
| 4,845,025 | Jul. 4, 1989 | Lary et al | 435 | 2 | Nov. 10, 1987 |
| 4,877,965 | Oct. 31, 1989 | Dandliker et al | 250 | 458.1 | Jul. 1, 1985 |
| 4,942,305 | Jul. 17, 1990 | Sommer | 250 | 574 | May 12, 1989 |
| 4,981,580 | Jan. 1, 1991 | Auer | 209 | 3.1 | May 1, 1989 |
| 4,983,038 | Jan. 8, 1991 | Ohki et al | 356 | 246 | Apr. 7, 1988 |
| 5,005,981 | Apr. 9, 1991 | Schulte et al | 366 | 219 | Sep. 8, 1989 |
| 5,007,732 | Apr. 16, 1991 | Ohki et al | 356 | 73 | Apr. 18, 1988 |
| 5,030,002 | Jul. 9, 1991 | North, Jr. | 356 | 73 | Aug. 11, 1989 |
| 5,034,613 | Jul. 23, 1991 | Denk et al | 250 | 458.1 | Nov. 14, 1989 |
| 5,079,959 | Jan. 14, 1992 | Miyake et al | 73 | 864.85 | Sep. 8, 1989 |
| 5,098,657 | Mar. 24, 1992 | Blackford et al | 422 | 73 | Aug. 7, 1989 |
| 5,101,978 | Apr. 7, 1992 | Marcus | 209 | 3.1 | Nov. 27, 1989 |
| 5,127,729 | Jul. 7, 1992 | Oetliker et al | 356 | 317 | Oct. 15, 1986 |
| 5,144,224 | Sep. 1, 1992 | Larsen | 324 | 71.4 | Apr. 1, 1991 |
| 5,150,313 | Sep. 22, 1992 | Van den Engh et al | 364 | 569 | Apr. 12, 1990 |
| 5,159,397 | Oct. 27, 1992 | Kosaka et al | 356 | 73 | Sep. 5, 1991 |
| 5,159,403 | Oct. 27, 1992 | Kosaka | 356 | 243 | Mar. 19, 1991 |
| 5,167,926 | Dec. 1, 1992 | Kimura et al | 422 | 67 | Sep. 11, 1990 |
| 5,180,065 | Jan. 19, 1993 | Touge et al | 209 | 577 | Oct. 11, 1990 |
| 5,182,617 | Jan. 26, 1993 | Yoneyama et al | 356 | 440 | Jun. 29, 1990 |
| 5,199,576 | Apr. 6, 1993 | Corio et al | 209 | 564 | Apr. 5, 1991 |
| 5,215,376 | Jun. 1, 1993 | Schulte et al | 366 | 348 | Mar. 9, 1992 |
| 5,247,339 | Sep. 21, 1993 | Ogino | 356 | 73 | Sep. 5, 1991 |
| 5,259,593 | Nov. 9, 1993 | Orme et al | 266 | 78 | Apr. 16, 1992 |
| 5,260,764 | Nov. 9, 1993 | Fukuda et al | 356 | 73 | May 29, 1990 |
| 5,298,967 | Mar. 29, 1994 | Wells | 356 | 336 | Jun. 2, 1992 |
| 5,359,907 | Nov. 1, 1994 | Baker et al | 73 | 865.5 | Nov. 12, 1992 |
| 5,370,842 | Dec. 6, 1994 | Miyazaki et al | 422 | 82.06 | Nov. 20, 1992 |
| 5,412,466 | May 2, 1995 | Ogino | 356 | 246 | May 22, 1992 |
| 5,452,054 | Sep. 19, 1995 | Dewa et al | 355 | 67 | Nov. 21, 1994 |
| 5,466,572 | Nov. 14, 1995 | Sasaki, et al | 435 | 2 | Apr. 25, 1994 |
| 5,467,189 | Nov. 14, 1995 | Kreikebaum et al | 356 | 336 | Jan. 12, 1995 |
| 5,471,294 | Nov. 28, 1995 | Ogino | | | |
| 5,483,469 | Jan. 9, 1996 | Van den Engh et al | 364 | 555 | Aug. 2, 1993 |
| 5,523,573 | Jun. 4, 1996 | Hänninen et al | 250 | 459.1 | Dec. 28, 1994 |
| 5,558,998 | Sep. 24, 1996 | Hammond, et al | 435 | 6 | Jun. 5, 1995 |
| 5,596,401 | Jan. 21, 1997 | Kusuzawa | 356 | 23 | Sep. 14, 1994 |
| 5,601,235 | Feb. 11, 1997 | Booker et al | 239 | 4 | Nov. 15, 1994 |
| 5,602,039 | Feb. 11, 1997 | Van den Engh | 436 | 164 | Oct. 14, 1994 |
| 5,602,349 | Feb. 11, 1997 | Van den Engh | 73 | 864.85 | Oct. 14, 1994 |
| 5,641,457 | Jul. 24, 1997 | Vardanega, et al | 422 | 82.01 | Apr. 25, 1995 |
| 5,643,796 | Jul. 1, 1997 | Van den Engh et al | 436 | 50 | Oct. 14, 1904 |
| 5,650,847 | Jul. 22, 1997 | Maltsev et al | 356 | 336 | Jun. 14, 1995 |
| 5,672,880 | Sep. 30, 1997 | Kain | 250 | 458.1 | Mar. 15, 1996 |
| 5,675,401 | Oct. 7, 1997 | Wangler et al | 355 | 67 | Jun. 15, 1995 |
| 5,700,692 | Dec. 23, 1997 | Sweet | 436 | 50 | Sep. 27, 1994 |
| 5,707,808 | Jan. 13, 1998 | Roslaniec et al | 435 | 6 | Apr. 15, 1996 |
| 5,726,364 | Mar. 10, 1998 | Van Den Engh | 73 | 864.85 | Feb. 10, 1997 |
| 5,759,767 | Jun. 2, 1998 | Lakowicz et al | 435 | 4 | Oct. 11, 1996 |
| 5,777,732 | Jun. 7, 1998 | Hanninen et al | 356 | 318 | Apr. 27, 1995 |
| 5,786,560 | Jul. 28, 1998 | Tatah et al | 219 | 121.77 | Jun. 13, 1997 |
| 5,796,112 | Aug. 18, 1998 | Ichie | 250 | 458.1 | Aug. 9, 1996 |
| 5,815,262 | Sep. 29, 1998 | Schrof et al | 356 | 318 | Aug. 21, 1996 |
| 5,819,948 | Oct. 13, 1998 | Van den Engh | | | |
| 5,824,269 | Oct. 20, 1998 | Kosaka et al | | | |
| 5,835,262 | Nov. 10, 1998 | Iketaki et al | 359 | 352 | Dec. 28, 1995 |
| 5,912,257 | Jun. 15, 1999 | Prasad et al | 514 | 356 | Sep. 5, 1996 |
| 5,916,449 | Jun. 29, 1999 | Ellwart et al | | | |
| 6,133,044 | Oct. 17, 2000 | Van den Engh | | | |

| DOCUMENT | | | | |
|---|---|---|---|---|
| NO. | DATE | COUNTRY | CLASS | SUBCLASS |
| DE19549015 | Mar. 4, 1997 | Germany | 21 | 85 |
| EP 0781985 | Jul. 2, 1997 | Germany | | |
| A2 | | (Karls et al.) | | |
| EP025296A2 | Mar. 18, 1981 | Europe | G01N15 | 07 |
| EP0468100A1 | Jan. 29, 1992 | Europe | G01N15 | 14 |
| EP0160201A2 | Nov. 6, 1985 | Europe | G01N15 | 14 |
| FR2699678-A1 | Dec. 23, 1992 | France | G01N21 | 64 |
| JP61159135 | Jul. 18, 1986 | Japan | G01N21 | 17 |
| (A) | | | | |
| JP4126064 (A) | Apr. 27, 1992 | Japan | A23P1 | 08 |
| JP4126065 (A) | Apr. 27, 1992 | Japan | A23P1 | 12 |
| JP4126066 (A) | Apr. 27, 1992 | Japan | C12M1 | 02 |
| JP4126079 (A) | Apr. 27, 1992 | Japan | C12N9 | 48 |
| JP4126080 (A) | Apr. 27, 1992 | Japan | C12N9 | 90 |
| JP4126081 (A) | Apr. 27, 1992 | Japan | C12N15 | 02 |
| JP61139747 | Jun. 27, 1986 | Japan | G01N21 | 53 |
| (A) | | | | |
| JP2024535 | Jan. 26, 1990 | Japan | G01N015 | 14 |
| SU1056008 | Nov. 23, 1983 | Soviet Union | G01N021 | 24 |
| SU1260778- | Sep. 30, 1986 | Russia | G01N21 | 64 |
| A1 | | | | |
| WO 96/12171 | Apr. 25, 1996 | US | | |
| WO 99/44037 | Feb. 26, 1999 | English | G01N | 6 |

Asbury, C. L., et al., “Fluorescence Spectra of DNA Dyes Measured in a Flow Cytometer”, Cytometry: 24 pp 234-242, 1996
Bakker Schut, T. C., et al., “A new principle of cell sorting by using selective electroporation in a modified cell sorter”, Cytometry 11, 1990, pp 659-666.
Bigos, M., et al., “Nine Color Eleven Parameter Immunophenotyping using Three Laser Flow Cytometry”, Cytometry: 36, 1999, pp 36-45.
Ceruzzi, P., “History of Modem Computing”, MIT Press, Reference to Non-von Neumann.
Denk, W., et al. “Two-photon molecular excitation in laser scanning microscopy”, Handbook of Biological Confocal Microscopy. J. B. Pawley, ed., Plenum Press, New York. pp 444-458, 1995
Eastman Kodak Company, Hawk-Eye Works, Rochester, NY, Journal of the Optical Society of America; Vol. 44, no. 8, September 1953, pp. 592-597
Fuller, R. R. and Sweedler, J. V., “Characterizing Submicron Vesicles with Wavelength-Resolved Fluorescence in Flow Cytometry”, Cytometry: 25, 1996, pp 144-155.
Garner, D. L., et al, “Quantification of the X- and Y- Chromosome-Bearing Spermatozoa of Domestic Animals by Flow Cytometry”, Biology of Reproduction 28, pp. 312-321 (1983)
Gauci, M. R., et al., “Observation of Single-Cell Fluorescence Spectra in Laser Flow”, Cytometry 25, 1996, pp 388-393.
Goppert-Mayer, M., “Über Elementarakte mit zwei Quantensprüngen”, Annalen der Physik, pp. 273-294, 1931
Gottlinger, C., et at, “Operation of a Flow Cytometer”, Flow Cytometry and Cell Sorting, pp. 7-23 (1982)
Herweijer, H., et al., “High speed photodamage cell selection using bromodeoxyuridine/Hoechst 33342 photosensitized cell killing”, Cytometry 9, 1988, pp 143-149.
Herzenberg, L., et al., “Fluorescence-activated Cell Sorting”, Scientific American, 234(3), pp 108-117.
Horan, P. and Wheeless, Jr., L., “Quantitative Single Cell Analysis and Sorting”, Science, 198, pp 149-157, October 1977.
Johnson, L. A., “Sex Preselection by Flow Cytometric Separation of X and Y Chromosome-bearing Sperm Based on DNA Difference” a Review, Reprod. Fertil. Dev., 1995, 7, pgs. 893-903
Keij, J. F., “The ZAPPER: a flow cytometer for high speed photodamage cell selection”, PhD Thesis, 1994
Kinoshita, S., et al., “Spectroscopic Properties of Fluorescein in Living Lymphocytes”, Cytometry: 8, 1987, pp 35-41.
Manni, J., “Two-Photon Excitation Expands The Capabilities of Laser-Scanning Microscopy”, Biophotonics International, pp 44-52, 1996
Martin, J. C., and Jett, J. H., “Photodamage, a basis for super high speed cell selection”, Cytometry 2, 1981, pp 114.
Melamed, M. R., et al, “An Historical Review of the Development of Flow Cytometers and Sorters”, A Review for Cytometers and Sorters, pp. 3-9, (1979)
Pinkel, D., “Flow Chambers and Sample Handling”, Flow Cytometry Instrumentation and Data Analysis, pp. 77-128 (1985)
Piston, D. W., et al., “Three-dimensionally resolved NAD(P)H cellular metabolic redox imaging of the in-situ cornea with two-photon excitation laser scanning microscopy” J Of Microscopy 178:20-27, 1995
Piston, D. W., et al (1994). Two-photon-excitation fluorescence imaging of three-dimensional calcium ion activity. APPLIED OPTICS 33:662-669
Recktenwald, D., et al., Cell Separation Methods & Applications New York: Marcel Dekker Inc, 1998.
Shapiro, H., “Practical Flow Cytometry”, Alan R. Liss, Inc., 1985.
Sharpe, J., “Thesis: An Introduction of Flow Cytometry,” Chptr. 2-2.2, 1997
Sharpe, J., “Thesis: Sperm Sexing - Method of Johnson et al.”, Chptr. 3.6 to 4.34 (1997)
Sharpe, J. “Thesis: Gender Preselection-Principle Scientific Options,” Chptr. 3.4 to 3.48 (1997)
Skogen-Hagenson, M. J., et al, “A High Efficiency Flow Cytometer”, The Journal of Histochemistry and Cytochemistry, Vol. 25, No. 7, pp. 784-789 (1977)
U.S. application 08/323,270, entitled “High Speed Flow Cytometer Droplet Formation System”, filed Oct. 14, 1994
U.S. application 08/627,963, entitled “High Speed Flow Cytometer Droplet Formation System”, filed Apr. 15, 1996
U.S. application 09/032,733, entitled “Method and Apparatus for Flow Cytometry”, filed on Feb. 27, 1998, 53 pages and 5 figures
Van Dilla, M., “Overview of Flow Cytometry: Instrumentation and Data Analysis”, Flow Cytometry: Instrumentation and Data Analysis, pp. 1-8 (1985)
Williams, R. M. et al. “Two photon molecular excitation provides intrinsic 3-dimensional resolution for laser-based microscopy and microphotochemistry”, FASEB J. 8:804-813, 1944
“An Introduction to Flow Cytometry”, pp 5-7 and pp 33-42 and page 55.

In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. However, as to each of the above, to the extent that such information or statements incorporated by reference might be considered inconsistent with the patenting of this/these invention(s) such statements are expressly not to be considered as made by the applicant(s).

In addition, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible in countries such as Australia and the like.

Thus, the applicant(s) should be understood to have support to claim at least: I) each of the liquid to gas conversion devices described herein, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, and the x) the various combinations and permutations of each of the elements disclosed In addition, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible in countries such as Australia and the like.

The claims set forth in this specification below are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

We claim:

1. A material transfer apparatus, comprising:
a. at least one material, having material location coordinates;
b. a material locator system;
c. a material transfer element responsive to said material locator system;
d. a selectably engaged flow path responsive to said material transfer element; and
e. a material differentiation system responsive to said selectably engaged flow path.

2. A material transfer apparatus as described in claim 1, wherein said at least one material comprises a plurality of liquid samples.

3. A material transfer apparatus as described in claim 2, further comprising cells entrained within said plurality of liquid samples.

4. A material transfer apparatus as described in claim 3, further comprising a multiple welled tray, wherein each well of said multiple welled tray corresponds to one of said plurality of liquid samples each having material location coordinates.

5. A material transfer apparatus as described in claim 4, wherein said material locator system comprises:
a. a memory element having a programmable material location coordinates tracker function; and
b. a tracker element responsive to said programmable material location coordinate tracking function.

6. A material transfer apparatus as described in claim 5, wherein said tracker element comprises a positionable material probe responsive to said programmable material location coordinate tracking function.

7. A material transfer apparatus as described in claim 6, wherein said material transfer element comprises:
a. a material interaction element responsive to said at least one material;
b. a second selectably engaged flow path fluidicly coupled to said material interaction element; and
c. a pressure differential generation element coupled to said selectably engaged flow path.

8. A material transfer apparatus as described in claim 7, wherein said material differentiation system is selected from the group consisting of a flow cytometer, a chromatograph, a high pressure liquid chromatograph, and a mass spectrometer.

9. A material transfer apparatus as described in claim 8, wherein said selectably engaged flow path comprises:
a. a stationary surface;
b. a rotational surface rotatably engaged to said stationary surface;
c. a rotational surface recess element, wherein said a rotational surface rotatably engaged to said stationary surface define an enclosed volume, and wherein said enclosed volume rotatably aligns with a flow path.

10. A material transfer apparatus as described in claim 9, further comprising a fluid stream within said first fluid path.

11. A material transfer apparatus as described in claim 10, further comprising a material within said first fluid stream.

12. A material transfer apparatus as described in claim 11, wherein said material within said first fluid stream comprises entrained particles.

13. A material transfer apparatus as described in claim 12, wherein said entrained particles comprise cells.

14. A material transfer apparatus as described in claim 13, further comprising a portion of said first fluid stream sequestered in said at least one enclosed rotor volume.

15. A material transfer apparatus as described in claim 14, further comprising a second pair of apertures, wherein said at least one enclosed rotor volume rotatably aligns with said second pair of apertures to engage a second flow path.

16. A material transfer apparatus as described in claim 15, further comprising a second fluid stream within said second flow path.

17. A material transfer apparatus as described in claim 16, wherein said portion of said first fluid stream is introduced into said second fluid stream when said enclosed rotor volume rotatably aligned with said second pair of apertures.

18. A material transfer apparatus as described in claim 17, wherein said second fluid stream exits said second fluid path at a target location within a particle differentiation system.

19. A material transfer apparatus as described in claim 18, wherein said target location comprises an aperture element of an injection tube and wherein said particle differentiation system comprises a flow cytometer.

20. A material transfer apparatus as described in claim 19, further comprising a zone of interrogation.

21. A material transfer apparatus as described in claim 20, wherein said second fluid path from said at least one enclosed rotor volume to said injection tube has a volume of less than ten microliters.

22. A material transfer apparatus as described in claim 21, wherein said second fluid stream comprises a sheath fluid.

23. A material transfer apparatus as described in claim 22, further comprising a third pair of apertures, wherein said at least one enclosed rotor volume rotatably aligns with said third pair of apertures to engage a third flow path.

24. A material transfer apparatus as described in claim 23, further comprising a third fluid stream within said flow path.

25. A material transfer apparatus as described in claim 24, wherein said third fluid stream comprises a wash fluid.

26. A material transfer apparatus as described in claim 25, wherein said at least one enclosed rotor volume serially engages said first flow path, said second flow path, and said third flow path.

27. A material transfer apparatus as described in claim 26, wherein said rotor surface has a single direction of rotation.

28. A material transfer apparatus as described in claim 27, wherein said at least one enclosed rotor volume introduces said portion of said first fluid stream into said second fluid stream at a rate of one introduction per about one second to about one introduction per about five seconds.

29. A material transfer apparatus as described in claim 28, wherein said at least one enclosed rotor volume comprises a selectable volume between about one microliter to about five microliters.

30. A method of transferring material, comprising the steps of:
a. providing at least one material each of said at least one material having material location coordinates;
b. locating said material at said material location coordinates;
c. transferring said material from said location coordinates;
d. selectably engaging a flow path responsive to said material; and
e. differentiating materials in said flow path.

31. A method of transferring material as described in claim 30, wherein said step of providing at least one material having material location coordinates comprises providing a plurality of liquid materials.

32. A method of transferring material as described in claim 31, further comprising the step of entraining cells in said plurality of liquid materials.

33. A method of transferring material as described in claim 32, further comprising the step of locating said plurality of liquid materials in a multiple welled tray, wherein each one of said plurality of liquid materials has a location in a corresponding one well of said multiple welled tray, and wherein each of said one well of said multiple welled tray has said material location coordinates.

34. A method of transferring material as described in claim 33, further comprising the steps of:
a. programming a memory element with a location coordinates tracker function; and
b. tracking said location coordinates in response to said location coordinates tracker function.

35. A method of transferring material as described in claim 34, wherein said step of tracking said location coordinates in response to said location coordinates tracker function comprises positioning a material probe at a location corresponding to said material location coordinates in response to said location coordinates tracker function.

36. A method of transferring material as described in claim 35, further comprising the steps of:
a. interacting with said material at said location coordinates;
b. selectably engaging a flow path fluidicly coupled to said material;
c. generating a pressure differential in said flow path; and
d. moving said material from said location coordinates within said flow path.

37. A method of transferring material as described in claim 36, wherein said step of selectably engaging a flow path responsive to said material comprises:
a. providing a rotatable surface with at least one recess element;
b. engaging a stationary surface with said rotatable surface to generate at least one enclosed rotatable volume;
c. rotating said rotatable surface to engage said at least one rotatable enclosed volume with said flow path. (rotatably positioned able)

38. A method of transferring material as described in claim 37, further comprising the step of sequestering a portion of said material within said rotatable enclosed volume.

39. A method of transferring material as described in claim 38, further comprising the step of rotating said rotatable surface to engage said at least one rotatable enclosed volume with a second flow path.

40. A method of transferring material as described in claim 39, further comprising the step of flowing a second fluid stream within said second flow path.

41. A method of transferring material as described in claim 40, further comprising the step of introducing said portion of said material into said second fluid stream.

42. A method of transferring material as described in claim 41, further comprising the step of delivering said portion of said material to a target location within a particle differentiation system.

43. A method of transferring material as described in claim 42, wherein said step of delivering said portion of said first fluid stream to a target location within a particle differentiation system comprises ejecting said portion of said material from said second flow path into a flow cytometer nozzle.

44. A method of transferring material as described in claim 43, further comprising the step of interrogating said particles entrained within said portion of said fluid stream.

45. A method of transferring material as described in claim 44, further comprising the step of minimizing volume of said second fluid path between said enclosed rotation volume to said ejection location.

46. A method of transferring material as described in claim 45, wherein said step of minimizing volume of said second fluid path between said enclosed rotation volume to said ejection location comprises reducing said volume to between about 1 microliter to about 10 microliters.

47. A method of transferring material as described in claim 46, further comprising the step of rotating said rotatable surface to engage said at least one rotatable enclosed volume with a third flow path.

48. A method of transferring material as described in claim 47, further comprising the step of flowing a third fluid stream within said third flow path.

49. A method of transferring material as described in claim 48, wherein said step of flowing a third fluid stream within said third flow path comprises flowing a wash fluid in said third flow path.

50. A method of transferring material as described in claim 49, further comprising the step of washing said rotatable enclosed volume.

51. A method of transferring material as described in claim 50, further comprising the step of serially engaging said flow path, said second flow path, and said third flow path.

52. A method of transferring material as described in claim 51, wherein said step of serially engaging said flow path, said second flow path, and said third flow path comprises rotating said rotatable surface in a single direction of rotation.

53. A method of transferring material as described in claim 52, wherein said step of introducing said portion of said material into said second fluid stream comprises introducing said portion of said material into said second fluid stream at a rate of one introduction per about 1 second to about one introduction per about five seconds.

54. A selectably engaged flow path, comprising:
a. a stationary surface;
b. a rotational surface rotatably engaged to said stationary surface;
c. at least one rotational surface recess element, wherein said at least one rotor surface recess element and said stationary surface define at least one enclosed rotor volume; and
d. a first pair of apertures, wherein said at least one enclosed rotor volume rotatably aligns with said first pair of apertures to engage a first flow path.

55. A selectably engaged flow path as described in claim 54, further comprising a fluid stream within said first fluid path.

56. A selectably engaged flow path as described in claim 55, further comprising a material within said first fluid stream.

57. A selectably engaged flow path as described in claim 56, wherein said material within said first fluid stream comprises entrained particles.

58. A selectably engaged flow path as described in claim 57, wherein said entrained particles comprise cells.

59. A selectably engaged flow path as described in claim 54, further comprising a portion of said first fluid stream sequestered in said at least one enclosed rotor volume.

60. A selectably engaged flow path as described in claim 59, further comprising a second pair of apertures, wherein said at least one enclosed rotor volume rotatably aligns with said second pair of apertures to engage a second flow path.

61. A selectably engaged flow path as described in claim 60, further comprising a second fluid stream within said second flow path.

62. A selectably engaged flow path as described in claim 61, wherein said portion of said first fluid stream is introduced into said second fluid stream when said enclosed rotor volume rotatably aligned with said second pair of apertures.

63. A selectably engaged flow path as described in claim 62, wherein said second fluid stream exits said second fluid path at a target location within a particle differentiation system.

64. A selectably engaged flow path as described in claim 63, wherein said target location comprises an aperture element of an injection tube and wherein said particle differentiation system comprises a flow cytometer.

65. A selectably engaged flow path as described in claim 64, further comprising a zone of interrogation.

66. A selectably engaged flow path as described in claim 65, wherein said second fluid path from said at least one enclosed rotor volume to said injection tube has a volume of less than ten microliters.

67. A selectably engaged flow path as described in claim 66, wherein said second fluid stream comprises a sheath fluid.

68. A selectably engaged flow path as described in claim 67, further comprising a third pair of apertures, wherein said at least one enclosed rotor volume rotatably aligns with said third pair of apertures to engage a third flow path.

69. A selectably engaged flow path as described in claim 68, further comprising a third fluid stream within said flow path.

70. A selectably engaged flow path as described in claim 70, wherein said third fluid stream comprises a wash fluid.

71. A selectably engaged flow path as described in claim 70, wherein said at least one enclosed rotor volume serially engages said first flow path, said second flow path, and said third flow path.

72. A selectably engaged flow path as described in claim 71, wherein said rotor surface has a single direction of rotation.

73. A selectably engaged flow path as described in claim 72, wherein said at least one enclosed rotor volume introduces said portion of said first fluid stream into said second fluid stream at a rate of one introduction per about one second to about one introduction per about five seconds.

74. A selectably engaged flow path as described in claim 73, wherein said at least one enclosed rotor volume comprises a selectable volume between about one microliter to about five microliters.

75. A method of selectably engaging a flow path, comprising the steps of:
a. providing a rotatable surface with at least one recess element;
b. engaging a stationary surface with said rotatable surface to generate at least one enclosed rotatable volume;
d. perforating said stationary surface with at least one pair of aperture elements;
e. rotating wherein said at least one enclosed volume rotatably aligns with said at least one pair of apertures to selectably engage a first fluid path.

76. A method of selectably engaging a flow path as described in claim 75, further comprising the step of flowing a fluid stream within said at least one fluid path.

77. A method of selectably engaging a flow path as described in claim 76, further comprising the step of entraining particles within said fluid stream.

78. A method of selectably engaging a flow path as described in claim 77, wherein said step of entraining particles within said fluid stream comprises entraining cells within said fluid stream.

79. A method of selectably engaging a flow path as described in claim 75, further comprising the step of sequestering a portion of said fluid stream within said enclosed rotational volume.

80. A method of selectably engaging a flow path as described in claim 79, further comprising the step of perforating said stationary surface with a second pair of aperture elements.

81. A method of selectably engaging a flow path as described in claim 80, further comprising the step of aligning said at least one enclosed rotation volume with said second pair of aperture elements to engage a second flow path.

82. A method of selectably engaging a flow path as described in claim 81, further comprising the step of flowing a second fluid stream within said second flow path.

83. A method of selectably engaging a flow path as described in claim 82, further comprising the step of introducing said portion of said first fluid stream into said second fluid stream.

84. A method of selectably engaging a flow path as described in claim 83, further comprising the step of delivering said portion of said first fluid stream to a target location within a particle differentiation system.

85. A method of selectably engaging a flow path as described in claim 84, wherein said step of delivering said portion of said first fluid stream to a target location within a particle differentiation system comprises injecting said portion of said fluid stream into a flow cytometer from an injector aperture.

86. A method of selectably engaging a flow path as described in claim 85, further comprising the step of interrogating said particles entrained within said portion of said fluid stream.

87. A method of selectably engaging a flow path as described in claim 86, further comprising the step of minimizing volume of said second fluid path between said enclosed rotation volume to said injector aperture.

88. A method of selectably engaging a flow path as described in claim 87, wherein said step of minimizing said volume of said second fluid path between said enclosed rotation volume to said injector aperture comprises reducing said volume of said second fluid path to between about 1 microliter to about 10 microliters.

89. A method of selectably engaging a flow path as described in claim 88, further comprising the step of aligning said at least one enclosed rotation volume with a third pair of aperture elements to engage a third flow path.

90. A method of selectably engaging a flow path as described in claim 89, further comprising the step of flowing a third fluid stream within said third flow path.

91. A method of selectably engaging a flow path as described in claim 90, wherein said step of flowing a third fluid stream within said third flow path comprises flowing a wash fluid in said third flow path.

92. A method of selectably engaging a flow path as described in claim 91, further comprising the step of washing said enclosed rotation volume.

93. A method of selectably engaging a flow path as described in claim 92, further comprising the step of serially engaging said first flow path, said second flow path, and said third flow path.

94. A method of selectably engaging a flow path as described in claim 93, wherein said step of serially engaging said first flow path, said second flow path, and said third flow path comprises rotating said rotatable surface in a single direction of rotation.

95. A method of selectably engaging a flow path as described in claim 94, wherein said step of introducing said portion of said first fluid stream into said second fluid stream comprises introducing said portion of said first fluid stream into said second fluid stream at a rate of one introduction per about 1 second to about one introduction per about five seconds.

96. A selectably engaged flow path, comprising:
a. a stationary surface;
a. a rotatable surface having at least one pair of rotatable surface recess elements, wherein said at least one pair of rotatable surface recess elements and said stationary surface define at least one pair of rotatable enclosed volumes; and
d. at least one stationary surface recess element, wherein said at least one stationary surface recess element and said rotational surface define at least one stationary enclosed volume, and wherein said at least one pair of enclosed rotor volumes rotatably align with said stationary enclosed volume.

97. A selectably engaged flow path as described in claim 96, further comprising a fluid path engaged when said at least one pair of rotatable enclosed volumes align with said stationary enclosed volume.

98. A selectably engaged flow path as described in claim 97, further comprising a fluid stream within said fluid path.

99. A selectably engaged flow path as described in claim 98, wherein said stationary enclosed volume holds an amount of liquid of less than about two microliters.

100. A selectably engaged flow path as described in claim 99, wherein a first rotatable enclosed volume of said at least one pair of rotatable enclosed volumes holds an amount of liquid between about 1 microliter to about 5 microliters.

101. A selectably engaged flow path as described in claim 100, wherein a second rotatable enclosed volume of said at least one pair of rotatable enclosed volumes holds an amount of liquid between about 1 microliter to about 5 microliters of liquid.

102. A selectably engaged flow path as described in claim 101, wherein said first rotatable enclosed volume holds a different amount of liquid than said second rotatable enclosed volume.

103. A selectably engaged flow path as described in claim 102, wherein said amount of liquid held by said first rotatable enclosed volume has a variably adjustable rate of introduction into said fluid stream.

104. A selectably engaged flow path as described in claim 103,wherein said amount of liquid held by said second rotatable enclosed volume has a variably adjustable rate of introduction into said fluid stream.

105. A selectably engaged flow path as described in claim 104, further comprising cells entrained in said amount of liquid held by said first rotatable enclosed volume.

106. A selectably engaged flow path as described in claim 105, further comprising cells entrained in said amount of liquid held by said second rotatable enclosed volume.

107. A selectably engaged flow path as described in claim 106, further comprising at least one material entrained in said amount of liquid held by said first rotatable enclosed volume.

108. A selectably engaged flow path as described in claim 107, further comprising at least one material entrained in said amount of liquid held by said second rotatable enclosed volume.

109. A selectably engaged flow path as described in claim 108, wherein said material entrained in said amount of liquid and said cells entrained in said volume of liquid form a product when mixed.

110. A selectably engaged flow path as described in claim 109, wherein said variably adjustable rate of introduction into said fluid stream responds differentially to an amount of product formed between said material and said cells.

111. A selectably engaged flow path as described in claim 110, wherein said variably adjustable rate of introduction into said fluid stream responds differentially to a rate of said product formation.

112. A selectably engaged flow path as described in claim 111, further comprising a second fluid path rotatably engaged by said at least one pair of rotatable enclosed volumes.

113. A selectably engaged flow path as described in claim 112, further comprising a third fluid path rotatably engaged by said at least one pair of rotatable enclosed volumes.

114. A selectably engaged flow path as described in claim 113, wherein a first of said pair of enclosed rotor volumes and a second of said pair of enclosed rotor volumes rotatably engage separate fluid paths.

115. A selectably engaged flow path as described in claim 114, wherein said separate fluid streams comprise a first separate fluid path fluidicly coupled to a sample transfer element and a second stream fluidicly coupled to a material source.

116. A selectably engaged flow path as described in claim 115, wherein said separate fluid streams comprise a first separate fluid path fluidicly coupled to a material source and a second separate fluid path fluidicly coupled to a material source.

117. A method of selectably engaging a flow path, comprising the steps of:
a. sequestering an amount of a first material;
b. sequestering an amount of a second material;
c. fluidicly coupling said amount of said first material and said amount of said second material to a fluid stream;
d. introducing said first material into said fluid stream at a first location;
introducing said second material into said fluid stream at a second location;
f. entraining said first material and said second material within said fluid stream; and
g. mixing said amount of said first material with said amount of said second material to a substantially homogeneous mixture in a fluid path having a volume of less than five microliters.

118. A method of selectably engaging a flow path as described in claim 117, wherein said step of sequestering said amount of said first material comprises sequestering a volume of a first fluid.

119. A method of selectably engaging a flow path as described in claim 118, wherein said step of sequestering said amount of said second material comprises sequestering a volume of a second fluid.

120. A method of selectably engaging a flow path as described in claim 119, wherein said step of sequestering a volume of a first fluid further comprises the step of entraining particles within said volume of said first fluid.

121. A method of selectably engaging a flow path as described in claim 120, wherein said step of sequestering a volume of a second fluid further comprises the step of entraining particles within said volume of said second fluid.

122. A method of selectably engaging a flow path as described in claim 121, wherein said step of entraining particles within said volume of said first fluid comprises entraining cells.

123. A method of selectably engaging a flow path as described in claim 122, wherein said step of entraining particles within said volume of said second fluid comprises entraining cells.

124. A method of selectably engaging a flow path as described in claim 123, further comprising the step of transporting said substantially homogenous mixture to a particle analysis system.

125. A method of selectably engaging a flow path as described in claim 124, further comprising the step of pressurizing said fluid stream between about 50 pounds per square inch to about 150 pounds per square inch.

126. A method of selectably engaging a flow path as described in claim 125, wherein said step of mixing said first material with said second material to a substantially homogeneous mixture prior to exiting said fluid path comprises mixing a particle labeling material with said particles.

127. A method of selectably engaging a flow path as described in claim 126, wherein said step of sequestering an amount of a first material comprises sequestering a volume of between about one microliter to about five microliters.

128. A method of selectably engaging a flow path as described in claim 127, wherein said step of sequestering an amount of a second material comprises sequestering a volume of between about one microliter to about five microliters.

129. A method of selectably engaging a flow path as described in claim 128, wherein said step of sequestering an amount of a first material comprises sequestering a different amount of said first material than said second material.

130. A method of selectably engaging a flow path as described in claim 129, wherein said step of sequestering an amount of a first material and said step of sequestering an amount of a second material further comprise the steps of:
a. providing a rotatable surface having at least a first recess element and a second recess element;
b. engaging a stationary surface with said rotatable surface to generate said first enclosed volume and said second enclosed volume;
c. rotating said rotatable surface;
d. aligning said first enclosed volume a first flow path; and
e. aligning said second enclosed volume with a second flow path.

131. A method of selectably engaging a flow path as described in claim 130, further comprising the step of providing at least one stationary surface recess element, wherein said at least one stationary surface recess element and said rotatable surface define at least one enclosed stationary volume, and wherein said first enclosed volume and said second enclosed volume rotatably align with said stationary surface recess element.

132. A method of selectably engaging a flow path as described in claim 131, further comprising the steps of:
a. aligning said first enclosed volume with a third flow path; and
b. aligning said second enclosed volume with a fourth path.

133. A method of selectably engaging a flow path as described in claim 132, further comprising the steps of:
a. flowing a third fluid stream within said third flow path; and
b. flowing a fourth fluid stream within said fourth flow path.

134. A method of selectably engaging a flow path as described in claim 133, wherein said third fluid stream and said fourth fluid stream comprise a cleaning fluid.

135. A method of selectably engaging a flow path as described in claim 134, further comprising the steps of:
a. cleaning said first enclosed volume; and
b. cleaning said second enclosed volume.

136. A method of selectably engaging a flow path as described in claim 135, further comprising the steps of:
a. engaging said first enclosed volume with said third fluid path and said second enclosed volume with said fourth fluid path substantially simultaneously;
b. rotating said rotation surface with respect to said stationary surface to engage said first enclosed volume with said first fluid path and said second enclosed volume with said second fluid path substantially simultaneously; and
c. rotating said rotation surface with respect to said stationary surface to engage said first enclosed volume and said second enclosed volume with said at least one stationary surface recess element.

137. A method of selectably engaging a flow path as described in claim 136, further comprising the step of rotating said rotation surface in a single direction of rotation.
